(19) United States
(12) Patent Application Publication
(10) Pub. No.: US 2012/0296833 A1
(43) Pub. Date: Nov. 22, 2012

(54) SYSTEM AND METHOD OF IMPROVED GROUP COLLABORATION

(76) Inventor: Puneet Sharma, Norcross, GA (US)

(21) Appl. No.: 13/155,360

(22) Filed: Jun. 7, 2011

Related U.S. Application Data
(60) Provisional application No. 61/488,787, filed on May 22, 2011.

(51) Int. Cl. G06Q 10/00

(52) U.S. Cl. 705/300

(57) ABSTRACT

Technologies are described herein for delivering continuous high performance using a multi-stage group perspective collaboration system. In one aspect, a processor presents a user interface through which users of a group can collaborate with one another. A first perspective from a user of the group is received at a first stage of maturation. The first perspective is then presented as a first stage thread to the group for collaboration. The system determines whether an elevation condition has been met to elevate the first stage thread to a second stage of maturation. Upon determining that the elevation condition has been met, the system determines whether content similar to content associated with the first stage thread exists. Upon determining that content similar to content associated with the first stage thread does not exist, the system elevates the first stage thread from the first stage of maturation to the second stage of maturation.

### CROSS-REFERENCE TO RELATED APPLICATIONS

The present application is related to a patent application titled “SYSTEM AND METHOD OF IMPROVED GROUP COLLABORATION” (Attorney Docket No. 1002.02US01) by Puneet Sharma, residing in Norcross, Ga. filed on Jun. 7, 2011, Ser. No. ______ and a publication Ser. No. ______. The information contained in the above identified patent application is incorporated herein by reference in its entirety.

### TECHNICAL FIELD

The present disclosure is related to the field of organizational performance systems. In particular, the present disclosure is related to the field of delivering continuous high performance using a group perspective collaboration system.

### BACKGROUND

In today's world, people can easily express their individual perspectives through digital forms of communications, such as emails, blogs, tweets, status updates, message boards, and the like. Currently, aggregation technologies, such as Wikipedia, on-line forums, and the like, attempt to solicit and organize these individual perspectives to create a collaborative resource, such as a Wikipedia page or wikis centered on specific topics. However, because these aggregation technologies are unsophisticated, the collaborative resources generated by these aggregation technologies sometimes contain inaccurate, outdated, and irrelevant information that may not be relevant to the particular topic. Furthermore, users of these aggregation technologies are still required to expend significant time and effort to extract meaningful data. As such, existing aggregation technologies lack the sophistication to allow a large group of users to collaborate on many different issues simultaneously while limiting the generation of digital noise to a tolerable level.

In addition, existing group collaboration applications are limited to discussion boards, forums, and social networks. However, these options allow users to communicate with one another, but fail to provide a sophisticated platform through which continuous high performance is delivered within the organization.

It is with respect to these and others considerations that the disclosure made herein is presented.

### SUMMARY

Technologies are described herein for delivering continuous high performance using a group perspective collaboration system. The group perspective collaboration system may be implemented for use within an organization that includes a group of users, such that the group of users may utilize the group perspective collaboration system to derive, execute, and refine key drivers that drive continuous high performance within an organization.

In one aspect, a system, a computer readable medium and a computer implemented method of group collaboration is disclosed. In the system, a processor presents a user interface through which users of a group can collaborate with one another. A first perspective from a user of the group is received at a first stage of maturation. The first perspective is then presented as a first stage thread to the group for collaboration. The system determines whether an elevation condition has been met to elevate the first stage thread to a second stage of maturation. Upon determining that the elevation condition has been met, the system determines whether content similar to content associated with the first stage thread exists. Upon determining that content similar to content associated with the first stage thread does not exist, the system elevates the first stage thread from the first stage of maturation to the second stage of maturation.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a collaborative environment for driving continuous high performance using a group perspective collaboration system according to one or more embodiments presented herein;

FIG. 2 is a schematic drawing illustrating a three stage maturation process involving two parties according to one or more embodiments presented herein;

FIG. 3 is an enlarged view of a screenshot illustrating features of a header portion of the group perspective collaboration system according to one or more embodiments presented herein;

FIG. 4 is an enlarged view of a screenshot illustrating features of a first stage of maturation of the three stage maturation process according to one or more embodiments presented herein;

FIGS. 5A and 5B are enlarged views of screenshots illustrating features of a second stage of maturation of the three stage maturation process according to one or more embodiments presented herein;

FIGS. 6A and 6B are enlarged views of screenshots illustrating features of the third stage of maturation of the three stage maturation process according to one or more embodiments presented herein;

FIG. 7 is a workflow diagram illustrating a convergence mechanism between the three stages of maturation according to one or more embodiments presented herein;

FIG. 8 is a block diagram of an group perspective collaboration application according to one or more embodiments presented herein;

FIG. 9 is a logical flow diagram illustrating a process for delivering continuous high performance using a group perspective collaboration system according to one or more embodiments presented herein;

FIG. 10 is a logical flow diagram illustrating a process for directly amending an individual perspective according to one or more embodiments presented herein; and

FIG. 11 is a computer architecture diagram illustrating computing system hardware capable of delivering continuous high performance using a group perspective collaboration system according to one or more embodiments presented herein.

### DETAILED DESCRIPTION

The following description is directed to technologies for delivering continuous high performance using a group perspective collaboration system. The group perspective collaboration system may be implemented for use within an organization that includes a group of users, such that the group of users may utilize the group perspective collaboration system to derive, execute, and refine key drivers that deliver continuous high performance within an organization. Through the use of the technologies described herein, the group perspective collaboration system may provide a sophisticated online platform where the group of users may be able to discuss individual perspectives provided by the users. The group perspective collaboration system may be configured to utilize a rule based system to solicit substantive input from multiple users from the group, while minimizing the amount of digital noise that can be generated by a large group of users.

According to some embodiments, the group perspective collaboration system may be configured to deliver continuous high performance within the organization by allowing the group of users to collaborate in an organized manner to extract precise key drivers that deliver continuous high performance. A key driver may be any aspect that may contribute to improving the performance of the organization. For instance, traditional key drivers may include aspects focusing on employee satisfaction, customer retention, product innovation, and the like. However, traditional key drivers are too broad to allow organizations to accurately focus their energies on important issues that may improve the performance of the organization.

Through the use of the embodiments disclosed herein, an organization may be able to extract precise key drivers that are more specific and more accurate than the broader, generic key drivers that businesses currently focus on through the group collaboration system disclosed herein. It should be appreciated that although embodiments of the present disclosure described herein are geared towards delivering continuous high performance within an organization, the present disclosure includes concepts that may be implemented in a wide variety of applications. Those skilled in the art may appreciate that the concepts described herein may be utilized to allow a group of users to collaborate in an efficient and effective manner. The present disclosure may be utilized in applications, including but not limited to, students collaborating on assignments, journalists collaborating on articles, team members of a business unit collaborating on a presentation, employees collaborating with one another on various topics, and the like. It should further be appreciated that through aspects of the present disclosure, groups of users may enrich a discussion by utilizing tools to separate the signals from the noise in a simple yet effective manner. Furthermore, the present disclosure discloses a multi-stage system. However, it should be appreciated that one or more of the stages, in particular, the first stage of group collaboration, may be implemented as a single stage group perspective collaboration system.

As discussed above, there is a need in the marketplace for a sophisticated collaborative platform that allows a group of users to collaborate to derive key drivers that deliver continuous high performance within an organization. Existing group collaboration systems, such as discussion boards, forums, and email threads, are unsophisticated, unmanageable, and noisy. The present disclosure describes a sophisticated group perspective collaboration system that empowers a group of users to contribute individual perspectives, discuss the perspectives, extract key drivers that deliver continuous high performance, take actions based on the key drivers, and receive feedback on the actions taken.

While the subject matter described herein is presented in the general context of program modules that execute in conjunction with the execution of an operating system and application programs on a computer system or embedded processor system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration, as specific embodiments, or examples. Referring now to the drawings, in which like numerals represent like elements through the several figures, aspects of computer systems and computer-implemented methods for improved group collaboration within an organization will be described.

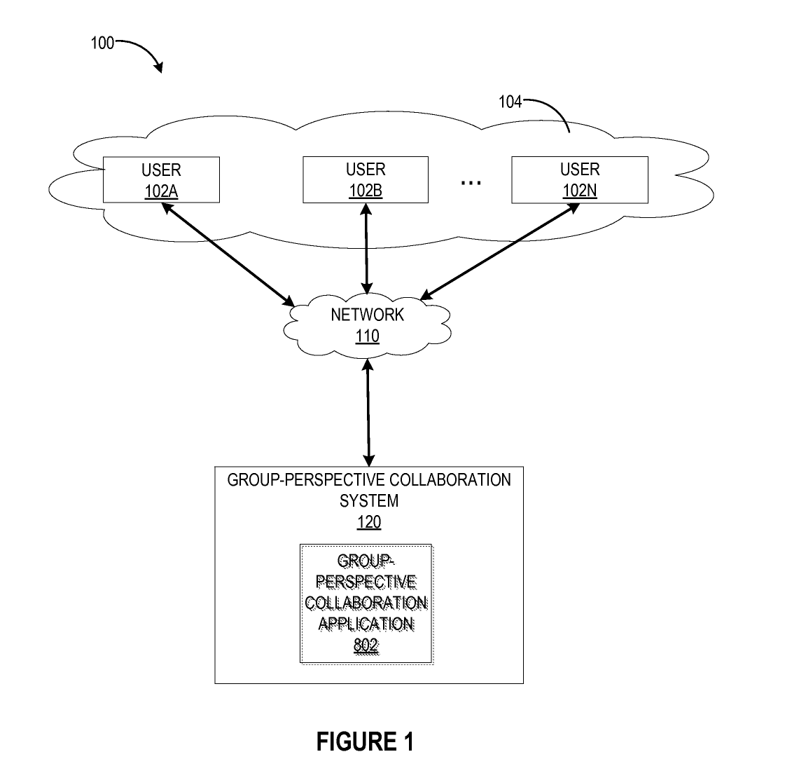

FIG. 1 is a block diagram illustrating a collaborative environment for driving continuous high performance using a group perspective collaboration system. In particular, FIG. 1 shows a collaborative environment 100 in which a group of users 102A-N, generally referred to hereinafter as users 102, are able to collaborate over a network 110 on a group perspective collaboration system 120. According to embodiments, the group of users may be associated with an organization 104. Individual users, such as the user 102A may be an employee, member, student, volunteer, or any other type of individual entity that is a part of the organization 104 and capable of collaborating with other users using the group perspective collaboration system 120. According to embodiments, the user 102 may be able to access the group perspective collaboration system 120 through a computing device, such as a laptop, desktop, smart phone, tablet, or any other computing device that allows a user to communicate with the group perspective collaboration system 120.

The group perspective collaboration system 120 may be configured to provide a platform on which the group of users can collaborate to derive key drivers that drive continuous high performance within the organization 104. Although various embodiments of the present disclosure may refer to the group perspective collaboration system 120 as a system through which a group of users are empowered to derive key drivers that drive continuous high performance within an organization, it should be appreciated that the scope of the present disclosure is not limited to such applications. Rather, the scope of the present disclosure extends to embodiments that may utilize the group perspective collaboration system for the purpose of allowing a group of users to easily and efficiently collaborate and communicate.

The group perspective collaboration system 120 may include a group perspective collaboration application 802 including computer-executable instructions, which when executed by a computer, causes the computer to provide the functionality associated with the group perspective collaboration system 120. In some embodiments, the group perspective collaboration system 120 may be configured to provide an online collaboration platform through which the users 102 may collaborate as a group to derive key drivers that drive continuous high performance within the organization 104.

The group perspective collaboration system 120 may be configured to present a user interface through which the group of users may interact with the group perspective collaboration system 120. The group perspective collaboration system 120 may define rules to facilitate user participation, solicit meaningful data, and minimize the generation of digital noise that is typically expected of a group of users within an organization. Furthermore, the group perspective collaboration system 120 may also define rules that allow the group of users to extract meaningful signals, such as key drivers from the digital noise. Additional details of various implementations of the group perspective collaboration system 120 will be described with reference to the drawings in general.

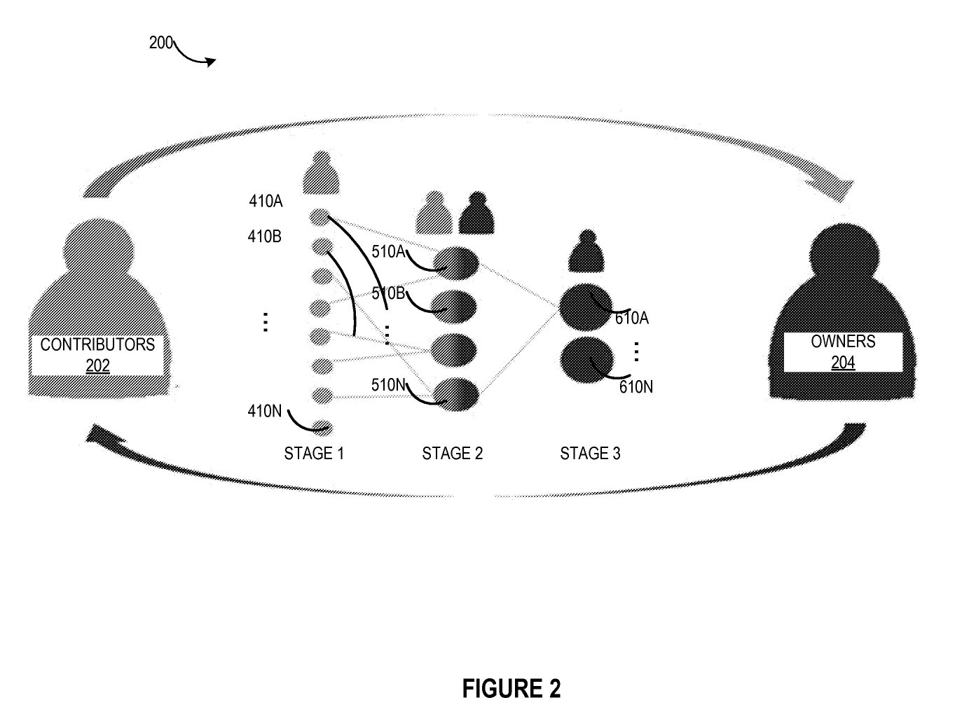

According to embodiments, a key driver may be derived from an individual perspective submitted by a user. Generally speaking, a perspective may include an idea, thought, view, question, or any other expression that the user is interested in sharing with the group. In some embodiments, a perspective may be any information that the user would like to share with the group, including but not limited to, multimedia files, links, presentations, documents, amongst others. From the individual perspective, the group may mature the individual perspective into a group perspective through discussion, convergence and elevation. In various embodiments described herein, the process of maturing an individual perspective into a key driver may involve three stages of maturation, which will be described in further detail with regard to FIG. 2.

Referring now to FIG. 2, a schematic drawing illustrating a three stage maturation process involving two parties is shown. According to various embodiments, the group perspective collaboration system 120 may define rules that outline a three stage maturation process. During the first stage, a user, such as the user 102A may submit an individual lead perspective to the group perspective collaboration system 120. The individual lead perspective may then be shared with the other users 102 of the group for discussion. In typical embodiments, the group perspective collaboration system 120 may generate a group perspective collaboration thread, such as the collaboration threads 410A-410N, generally referred to herein as collaboration threads 410. A collaboration thread, such as the collaboration thread 410A may include the lead perspective. In the first stage, users, as contributors 202 may mature the collaboration thread 410 by contributing to the collaboration thread 410 either by enhancing the lead perspective, submitting differing perspectives that are different from the lead perspective, or voting for or against a particular perspective within the collaboration thread, amongst other things. In essence, a contribution may be any action taken by a user to enrich the collaboration thread, even if it does not include adding new information. For instance, voting against a specific perspective or flagging a perspective for removal, are actions that may be contributions that enrich the collaboration thread.

One or more of the collaboration threads 410 in the first stage of maturation may be elevated to the second stage of maturation. According to embodiments, the collaboration threads 410 may be elevated to the second stage of maturation based on the activity of the particular collaboration thread. Collaboration threads 410 with a lot of activity are more likely to get elevated to the second stage of maturation relative to other collaboration threads 410 with limited activity. Activity may include various aspects, including the number of contributors participating in the collaboration thread, the number of votes received, the number of contributions, the frequency of contributions, the seniority of the contributors, and the like. All these aspects may be combined to generate a first stage maturation score, which may be utilized to determine if the collaboration thread 410 is mature enough to be elevated to the second stage of maturation. In some embodiments, once the first stage maturation score reaches a threshold first stage maturation score, the collaboration thread may be eligible for elevation to the second stage of the three stage maturation process. According to embodiments, the collaboration thread may be elevated manually by a user upon being eligible for elevation, or may be elevated automatically upon reaching the threshold first stage maturation score by the group-perspective collaboration system 120.

In some embodiments, a collaboration thread may be removed from the group-perspective collaboration system 120 if the collaboration thread fails to receive sufficient traction from the group of users. According to embodiments, the group-perspective collaboration system 120 may be configured to continuously analyze a maturation score of the collaboration thread. The maturation score may increase or decrease over time based on the amount of activity associated with the thread. As such, if a collaboration thread is not receiving a lot of activity over a period of time, the maturation score may decrease. According to some embodiments, the group-perspective collaboration system 120 may be configured to remove collaboration threads that have a maturation score that falls below a minimum threshold maturation score. To implement such a feature, the group-perspective collaboration system 120 may be configured to continuously or periodically calculate and monitor the maturation score of the collaboration threads. In this way, unimportant or irrelevant collaboration threads may be removed from the group-perspective collaboration system 120 so that only relevant data is presented to the group of users, thereby reducing the amount of digital noise in the group-perspective collaboration system 120.

Once a collaboration thread 410 elevates to the second stage of maturation, the collaboration thread 410 becomes a half-baked driver thread, such as the half-baked driver threads 510A-410N, generally referred to herein as half-baked driver threads 510. As illustrated in FIG. 2, the half-baked driver threads 510 appear larger than the collaboration threads 410 since the half-baked driver thread 510 may contain more substance than the corresponding collaboration threads from which the half-baked driver thread 510 evolved.

It should be appreciated that in various embodiments, a collaboration thread may be merged with an existing half-baked driver thread or a key driver thread. In addition, during each stage of maturation, such as the maturation of a collaboration thread to a half-baked driver thread and from a half-baked driver thread to a key driver thread, the group-perspective collaboration system 120 may be configured to encourage searching for previously existing threads that may be similar to the thread being elevated. In this way, if a more mature thread is similar to or matches the contents of the thread being elevated, the users, or in some embodiments, the group-perspective collaboration system 120 may decide to merge the thread being elevated with the existing thread. As a result, there may be fewer threads at the higher stages of maturation, but the size and quality of the threads at the higher stages of maturation may also be better. The process of searching and merging may be referred to as convergence, and is depicted by the lines between the collaboration threads 410 and the half-baked driver threads 510, and the lines between the half-baked driver threads 510 and the key driver threads 610.

During the second stage, one or more users 102 may become owners 204 of the half-baked driver threads 510. As an owner of the half-baked driver thread, the owner 204 may be assigned ownership privileges that allow the owner 204 to take decisions on a half-baked driver thread owned by the owner 204. In addition, the owner 204 may be responsible for managing and moderating the content of the half-baked driver thread. The group perspective collaboration system 120 may be configured to allow both contributors 202 and owners 204 to enhance the half-baked driver threads 510 such that the half-baked driver threads may be elevated to the third stage of maturation. Unlike the first stage, where the collaboration threads 410 only received contributions from contributors 202, the half-baked driver threads 510 may receive contributions from both contributors 202 and owners 204. The half-baked driver threads 510 may be elevated to the third stage of maturation based on the activity of the half-baked driver threads 510. The group perspective collaboration system 120 may determine a second stage maturation score based on factors similar to those utilized to determine the first stage maturation score. In addition, the second stage maturation score may also consider factors related to the owners of the half-baked driver threads, such as the number of owners, the contributions made by the owners, the rank of the owners within the organization, and so forth. According to embodiments, only half-baked driver threads 120 that have a corresponding second stage maturation score that exceeds a second stage threshold maturation score may be eligible for an elevation to the third stage of maturation. In various embodiments, even though a half-baked driver thread is eligible for elevation to the third stage of maturation, the half-baked driver thread may not be elevated until an owner requests that the half-baked driver thread be elevated to the third stage of maturation.

Once a half-baked driver thread 510 elevates to the third stage of maturation, the half-baked driver thread 510 becomes a key driver thread, such as the key driver threads 610A-610N, generally referred to herein as key driver threads 610. In various embodiments, the key driver thread includes a key driver that has been derived by the group of users. The key driver drives continuous high performance within the organization and therefore, owners of the key driver thread 610 may take actions related to the key driver. In addition, the owners of the key driver thread may also receive feedback from the group of users regarding the actions taken by the owners, and may accordingly take additional actions based on the feedback received. Furthermore, the owners may outline a roadmap associated with the key driver thread that outlines the performance of the key driver. Based on the actions taken by the owners and the feedback received from the contributors, the owners may evaluate the roadmap in its current state and amend future states of the roadmap by adding new actions to be performed, adjusting the anticipated performance of the key driver, amongst others. As such, by identifying the key drivers, taking actions on the key drivers, and making improvements based on feedback received on the actions, the owners are able to deliver continuous high performance within the organization.

In some embodiments, a key driver thread 610 may receive updates from contributors 202 and owners 204 to keep the key driver thread 610 relevant and up to date. Owners 204 of the key driver thread 610 may accept or reject these updates and the group-perspective collaboration system 120 may allow the key updates to merge into the roadmap or as a key action of the key driver thread 610. Accordingly, this feedback loop generates a refresh mechanism for keeping the key driver thread continuously updated and relevant.

The concept of delivering continuous high performance may relate to maturing individual perspectives into group perspectives, identifying key drivers from the group perspectives, taking actions on the key drivers, and receiving feedback on the actions taken on the key drivers. In this way, the users can collaborate to identify existing problems, determine solutions that address the existing problems, take actions to address the problems, receive feedback on the actions taken, and refine the process to deliver continuous high performance within the organization.

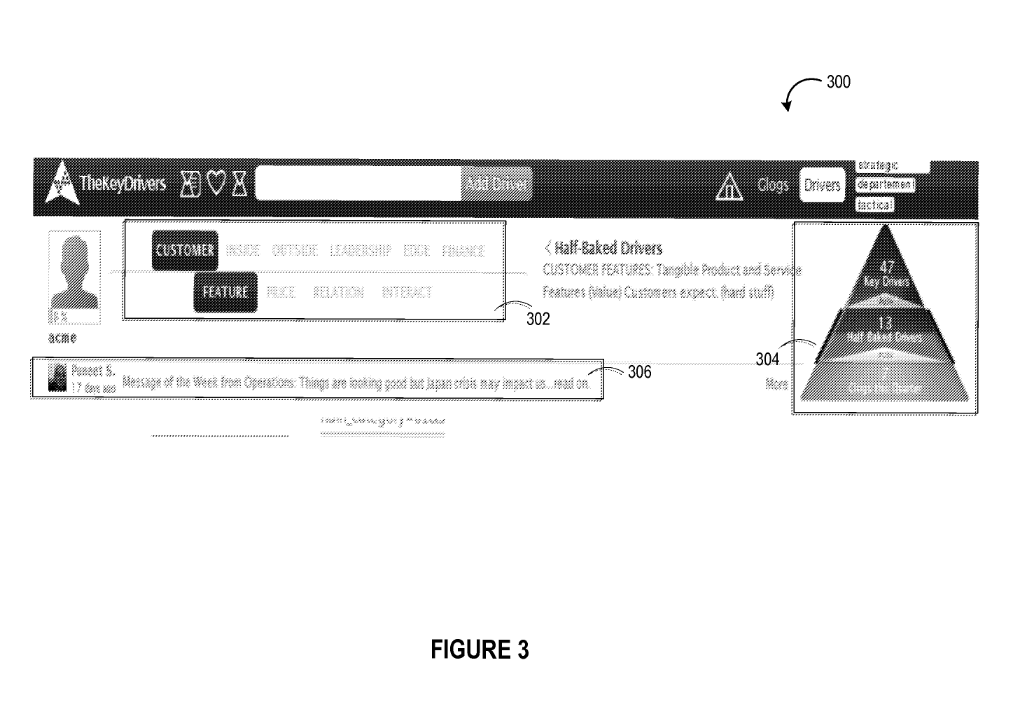

Referring now to FIG. 3, an enlarged view of a screenshot illustrating a header portion of a user interface of the group perspective collaboration system is shown. The header portion 300 may include various features that allow the users to navigate through the group perspective collaboration system 120, in addition to providing the users with updated information regarding the group perspective collaboration system 120.

The header portion 300 may include an area of focus menu 302, through which the users may be able to receive information associated with a particular area of focus. According to embodiments, the area of focus menu 302 may include one or more main focus units, each of which may include one or more sub-focus units. Using the area of focus menu 302, a user may be able to view group perspective threads pertaining to a specific area of focus within the organization. According to various embodiments, a dynamic notifier adjacent to the area of focus menu 302 may indicate the area of focus currently being presented to the user. Furthermore, a description describing the current area of focus indicated by the dynamic notifier may also appear adjacent to the dynamic notifier. The description may include a defined scope of the particular area of focus such that users may be reminded about the boundaries of the particular area of focus while interacting with the group-perspective collaboration system 120.

Moreover, the area of focus menu 302 may be configurable and scalable by an administrator of the group-perspective collaboration system 120. An administrator of the group-perspective collaboration system 120 may be a person who has administrative authorities to customize the look, features, and functions of the group-perspective collaboration system 120 so that the group-perspective collaboration system 120 may be more applicable to the particular organization within which it is being implemented.

In addition, the header portion 300 may also include a thread status icon 304 indicating the number of group perspective threads that are currently active in the particular area of focus. The thread status icon 304 may have a triangular shape, with three layers. The bottom layer may indicate the number of the collaboration threads 410, the middle layer may indicate the number of half-baked driver threads 510, and the top layer may indicate the number of key driver threads 610. Each of the layers of the thread status icon may be selectable, and the users may be able to view a thread feed associated with a particular type of group perspective thread by selecting a corresponding layer.

Furthermore, the header portion 300 may also include a leadership message ribbon 306, which displays messages posted by one or more users of the group perspective collaboration system 120. According to embodiments, the leadership message ribbon 306 may also display important alerts or any other message that a user may desire to broadcast to the group of users. According to some embodiments, only users having a specific designation or rank in the organization may be authorized to broadcast messages through the leadership message ribbon 306.

The header portion 300 may further include selectable icons, which when selected by the user, present various information to the user. For instance, the header portion 300 may include a personal feed icon, which when selected by the user, displays recently amended threads in which the user is either a contributor or an owner. Similarly, the header portion 300 may include a business feed that may display recently amended threads within the entire organization.

It should be appreciated that the header portion 300 may include alert icons that may alert the users when updates to the group perspective threads have been made by one or more users. Further, the user may be able to view only those group perspective threads in which the user is a contributor or an owner. In some embodiments, the user 102 may be able to view only those group perspective threads associated with the specific area of focus with which the user is associated. Moreover, it should be understood by those skilled in the art that the header portion may include other features not described herein but whose functionality may be illustrated in FIG. 3.

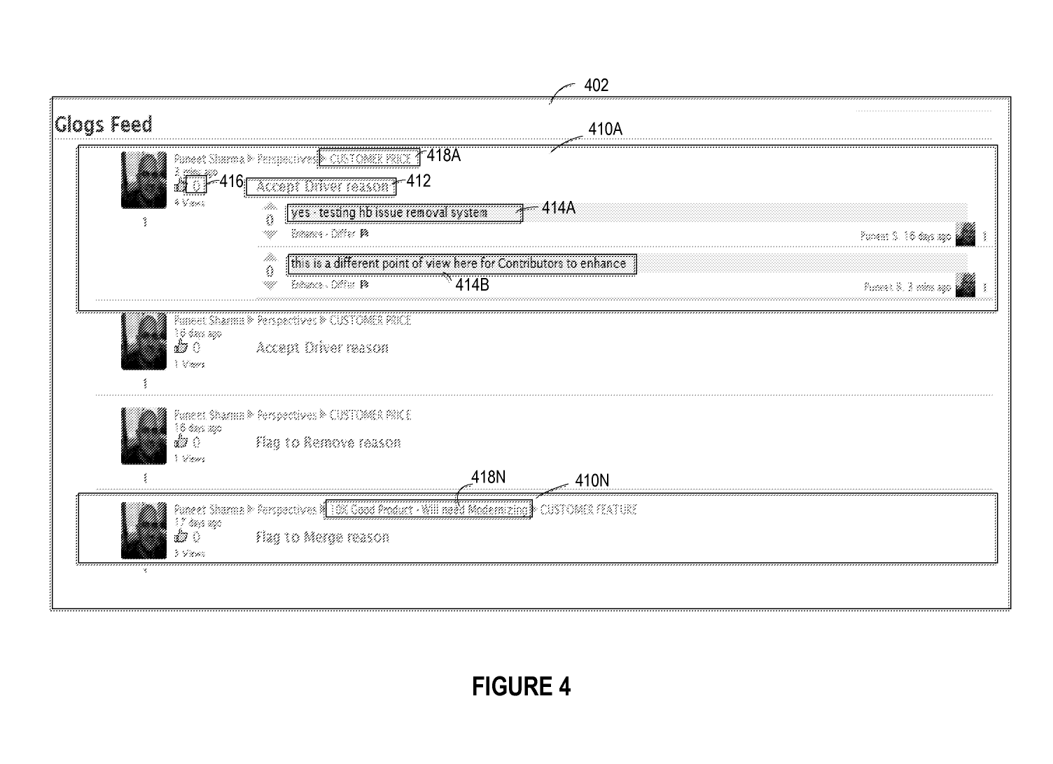

Referring now to FIG. 4, an enlarged view of a screenshot illustrating features of a first stage of maturation of the three stage maturation process is shown. In FIG. 4, a collaboration thread feed 402 may include one or more collaboration threads 410, such as the collaboration threads 410A and 410N. As described above, a collaboration thread 410 is generated from an original lead perspective. According to embodiments, a user 102 may submit an original lead perspective in the form of a title 412 summarizing the original perspective and a description 414A that describes the original lead perspective in more detail. It should be understood that the original lead perspective may be a question, an idea, a solution, a rant, a complaint, a request, or any expression or information the user would like to share with the group of users. In addition, each collaboration thread 410 may be associated with a particular area of focus within the organization. In this way, a user may classify the collaboration thread 410 under a particular area of focus to help group perspectives that are related to each other appear close together.

Once the user 102 submits the original lead perspective to the group perspective collaboration system 120, the group perspective collaboration system 120 may be configured to search the contents of the group perspective collaboration system 120 to determine if the original lead perspective matches or is similar to an existing group perspective thread. A group perspective thread may be any thread to which a user may be able to contribute. In some embodiments, a group perspective thread may be a collaboration thread, such as the collaboration threads 410A, 410N, or any other thread existing within the group perspective collaboration system 120, such as the half-baked driver threads 510 in the second stage or the key driver threads 610 in the third stage of maturation. The group perspective collaboration system 120 may then provide the search results to the user 102 such that the user 102 may decide whether to submit the original perspective as a new collaboration thread 410A, or to participate in one of the existing group perspective threads.

If the user decides to submit an original perspective as a new collaboration thread, the group perspective collaboration system 120 may generate a collaboration thread, such as the collaboration thread 410A. As mentioned above, the collaboration thread 410A includes the original perspective submitted by the user, which may comprise a title 412 summarizing the original perspective and a description 414A that describes the original perspective in more detail.

The users 102 may be able to contribute to the collaboration thread 410A as contributors 202 by submitting a directed amendment. According to embodiments, a directed amendment may include enhancing the description 414A or submitting a different perspective as an alternate description 414B. According to various embodiments, a contributor 202 may enhance the description 414A by editing the description 414A. To do so, the contributor 202 may submit a request to enhance the description 414A, upon which the group perspective collaboration system 120 may be configured to present a fillable text box containing the description 414A to the contributor 202 for editing. The contributor 202 may be able to delete some or all of the text of the description 414A and, additionally or alternatively, add additional text to the description 414A. In some embodiments, the description 414A may be displayed with track changes such that other users can see the changes made to the description 414A as well as the contributor 202 making the changes to the description 414A.

Alternatively, the contributor 202 may submit a request to differ from the description 414A, upon which the group perspective collaboration system 120 may be configured to present a blank fillable text box that is separate from the description 414A. Once the contributor 202 submits a different perspective in the blank fillable text box, the group perspective collaboration system 120 may present the collaboration thread 410A including the description 414A and the different perspective as a different description 414B. In various embodiments, the different description 414B may also be subjected to directed amendments in a manner similar to the description 414A. It should be appreciated that in various embodiments, the description may be in a rich media format, such as a video, audio, image file, and the like. As such, any revisions made to the description may include revisions made in a corresponding rich media format of the description.

Moreover, in some embodiments, the group perspective collaboration system 120 may be able to limit the number of different descriptions 414B associated with a particular collaboration thread, such as the collaboration thread 410A to a maximum threshold number of different descriptions. In this way, the amount of digital noise generated by the users may be limited and the users may be forced to contribute to the collaboration thread 410A within the existing parameters laid out by the other users. It should be appreciated that by limiting the number of differing perspectives to a threshold number, users may be forced to focus their attention on improving the perspectives that have already been provided by the group of users. In some embodiments, the user who provides the original lead perspective may specify the maximum threshold number of differing perspectives that the collaboration thread 410 may contain.

It should be appreciated that visual representations indicating the contributors 202 contribute directed amendments to the collaboration thread 410 may be displayed within the collaboration thread 410. In some embodiments, the contributions made by each of the contributors 202 may also be displayed to the users 102. By doing so, the group-perspective collaboration system 120 may encourage the users 102 to analyze the development of the collaboration thread 410 and the directed amendments made by the contributors 202. In this way, the users may be able to derive a general sense of the group perspective of a particular collaboration thread. As a result, future contributors 202 may be able to provide contributions that take into account the previous contributions made by the other contributors 202 of the collaboration thread 410, resulting in more relevant and meaningful contributions.

In some example embodiments, a directed amendment may include flagging a description, such as the description 414A or the description 414B of the collaboration thread 410A. According to embodiments, a contributor 202 may flag a description, such as the description 414A or 414B, to move the description to a different area of focus of the group perspective collaboration system 120. As described above, a contributor 202 submits an original perspective within an area of focus the user believes the original perspective belongs. However, another user may believe the collaboration thread 410 belongs in another area of focus. Accordingly, the contributor 202 may flag to move the collaboration thread 410 to the other area of focus. In various embodiments, other users of the group may need to validate the flag submission before any action is taken. A contributor 202 may also flag a description to delete the flagged description from the collaboration thread 410A, or to merge the flagged description with an existing group perspective thread in any of the three stages of the maturation process. In some embodiments, the contributor 202 may be able to flag the entire collaboration thread for deletion from the collaboration thread feed 402, for moving to a different area of focus, or for merging with another existing group perspective thread.

In addition, users may be able to contribute to the collaboration thread 410A by voting for or against one or more of the descriptions 414A, 414B contained within the collaboration thread 410A. In some embodiments, the group perspective collaboration system 120 may add the number of positive votes of each description and display the total as the total vote count for the collaboration thread 410A. The total number of votes associated with a collaboration thread 410 may help the group of users identify the collaboration threads 410A in which the group of users may be most interested. The process of voting allows users to indicate whether they believe a particular description 414 or collaboration thread 410 is a key driver of the organization. This is important as the group of users may be able to elevate important collaboration threads and/or descriptions to the second stage of maturation while identifying collaboration threads that the group believes may not be a key driver of the organization.

In addition, additional features of the collaboration thread feed 402 may be implemented to encourage the group of users to engage in the group perspective collaboration system 120. In various embodiments, the collaboration thread feed 402 may be configured to present the collaboration threads in which the user 102 is a contributor 202. The order in which the collaboration threads may appear in the collaboration thread feed may be based on the time since the last activity occurred within the corresponding collaboration thread. However, in some embodiments, any time a contributor contributes to the collaboration thread, the rest of the contributors 202 may be alerted of the contribution made to the collaboration thread. However, in some embodiments, a contributor contributing to the collaboration thread may choose to not publish the contribution. In such situations, the contribution made by the contributor is not published on the collaboration thread feed 402 of the users of the group that are associated with the corresponding collaboration thread.

In other example embodiments, the collaboration thread feed 402 may display collaboration threads 410 based on chronological order, reverse chronological order, latest received updates, number of views in descending order, number of votes in descending order, number of contributors in descending order, and the like. In some embodiments, the group perspective collaboration system 120 may display the most active collaboration thread in terms of total activity first, or alternatively, the most active thread in terms of the rate of activity first.

Furthermore, in some embodiments, each collaboration thread 410 may also identify the contributor 202 of the group that started the collaboration thread 410, the contributor 202 of the group that last contributed to the collaboration thread 410, as well as the contributor 202 of the group that last edited a description of the collaboration thread 410. In alternate embodiments, the collaboration thread 410 may include a graphical representation of the contributors 202 that made directed amendments to the collaboration thread, such that other users of the group may be able to evaluate the progress of the collaborative thread from a group-perspective as opposed to a series of individual contributions.

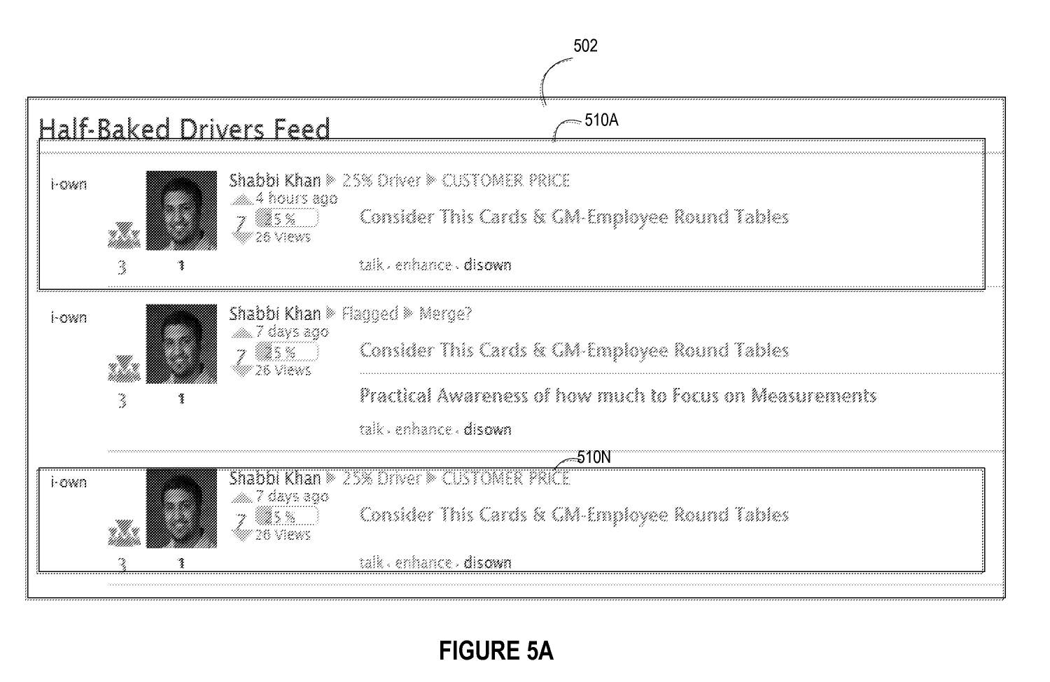

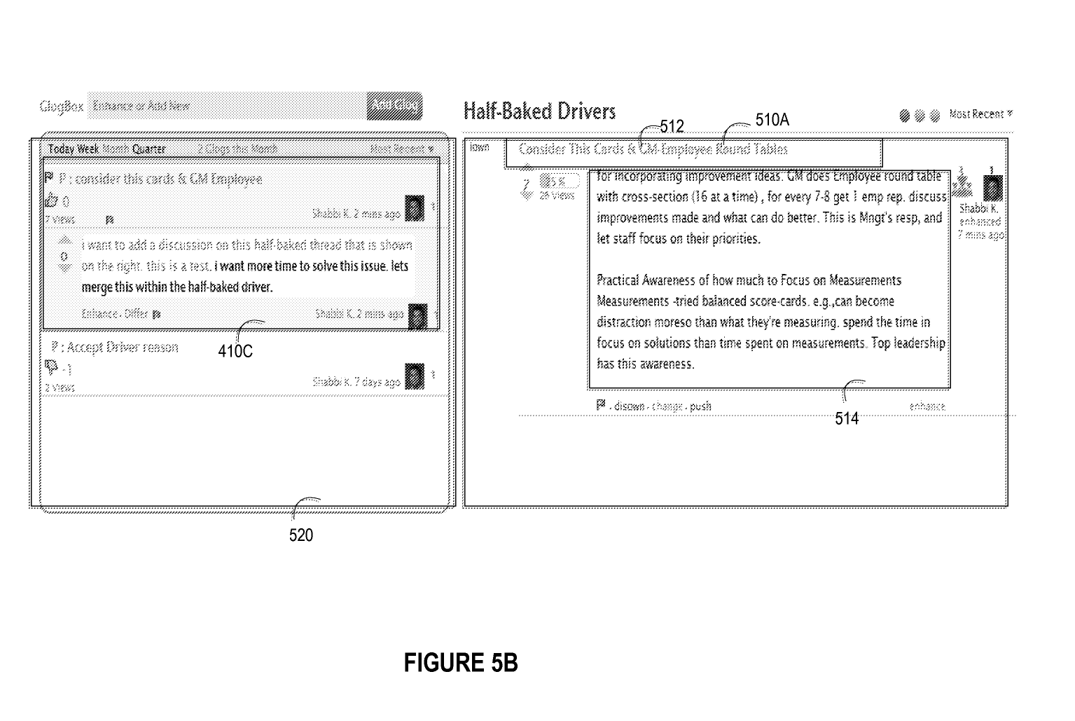

Referring now to FIGS. 5A and 5B, enlarged views of screenshots illustrating features of a second stage of maturation of the three stage maturation process is shown. In FIGS. 5A-5B, a half-baked thread feed 502 may include one or more half-baked driver threads 510, such as the half-baked driver threads 510A and 510N. Since these half-baked driver threads 510 evolve from collaboration threads 410, the half-baked driver threads 510 may include content that is similar to the corresponding collaboration threads 410. As such, the title 510 may be similar to the title of the collaboration thread 410 from which the half-baked driver thread 510 evolved. Similarly, the half-baked driver thread 510 may include one or more descriptions 514 that are similar to the descriptions 414 contained in the collaboration thread 410 from which the half-baked driver thread 510 evolved.

As shown in the screenshots of FIGS. 5A and 5B, various features of the half-baked driver feed 502 may be seen. For instance, contributors 202 may contribute to the half-baked driver thread 510 by engaging in a discussion regarding the half-baked driver thread 510 in a discussion box 520 dedicated to a particular half-baked driver thread 510. According to embodiments, contributors 202 may desire to share a perspective on the half-baked driver thread without polluting the half-baked driver thread itself. Since the group-perspective collaboration system 120 is configured to provide separate discussion boxes 520 for each of the half-baked driver threads 510, a contributor 202 may submit a perspective to the discussion box 520 as a collaboration thread, such as the collaboration thread 410C. As such, the discussion box 520 may include one or more collaboration threads 410 that are associated with the particular half-baked driver thread 510A. In this way, contributors 202 may contribute their perspectives in the collaboration threads 410 associated with the particular half-baked driver thread 510 to generate group perspectives. These group perspectives may then be utilized to enhance the descriptions contained within the half-baked driver thread 510, as well as enhance the half-baked driver thread 510 itself.

Contributors 202 may further contribute to the half-baked driver thread 510A by enhancing the description of the half-baked driver thread 510. As previously described, the contributor 202 may enhance the description of the half-baked driver thread 510 in place, which means that the contributor 202 may edit the contents of the description within the same description. Similarly, the contributor 202 may differ from the description of the half-baked driver thread 510 by submitting a perspective as a different description within the same thread, such as in the discussion box 520. By directing the contributor 202 to amend the half-baked driver thread 510 by either enhancing an existing description or submitting a new description having a different perspective, the contributors may 202 be guided to submit perspectives focused on the perspectives contained in the existing descriptions of the half-baked driver thread 514.

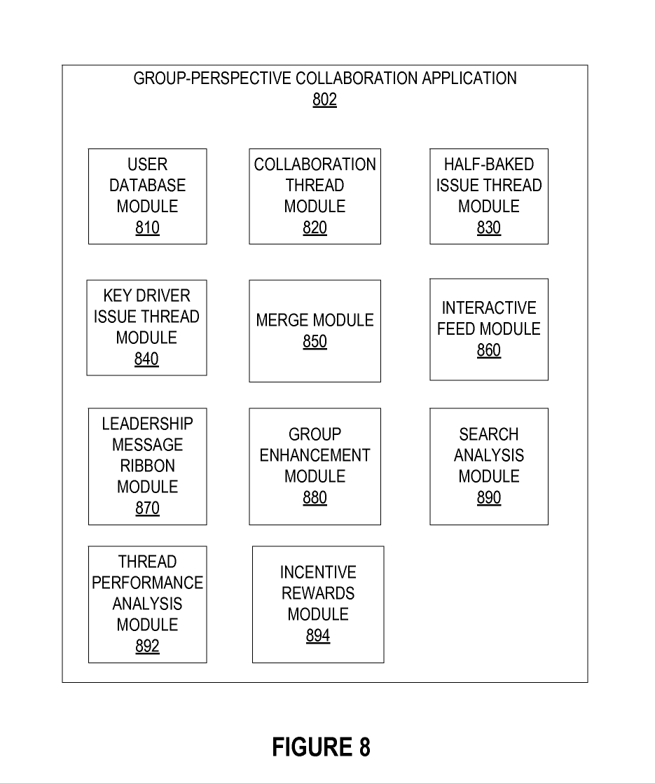

In addition, contributors 202 may contribute to the half-baked driver thread 510 by flagging a description 514 of the half-baked driver thread 510 or the entire half-baked driver thread 510. In various embodiments, a flag may be a request to delete the flagged object, to move the flagged object to another area of focus or another stage of maturation or both, or to merge the flagged object with another half-baked driver thread 510 or a key driver thread 610. It should be appreciated that even though a contributor 202 may flag a description 514 of the half-baked driver thread 510, an owner 204 of the half-baked driver thread 510 containing the flagged description 514 may be required to approve the flag request. In some embodiments, if a contributor flags a description 514 of the half-baked driver thread or the half-baked driver thread itself for merging with a candidate half-baked driver thread or candidate key driver thread, the owner of the candidate half-baked driver thread or key driver thread may also be required to approve the merge request. If the merge request is approved, the merge will be executed. Additional details regarding the merge process will be provided during a discussion of a merge module (see 860 in FIG. 8). However, if any of the owners of the involved threads denies the flag request, the merge request may be withdrawn.

Furthermore, contributors 202 of the half-baked driver thread 510 may also contribute to the half-baked driver thread 510 by voting for or against one or more descriptions contained within the half-baked driver thread, or voting for or against the half-baked driver thread itself. As previously discussed, the half-baked driver thread 510 is at the second stage of maturation. At this stage of maturation, the group-perspective collaboration system 120 may be configured to allow one or more contributors of the half-baked driver thread 510 to become an owner of the half-baked driver thread 510.

In addition, any user may be capable of taking ownership of the half-baked driver thread. As an owner of the half-baked driver thread, the owner 204 may be afforded special privileges not available to a contributor 202 such that the owner may be able to moderate and manage the half-baked driver thread 510. As described above, a contributor 202 may flag a description 514 or a half-baked driver thread 510 to either request a remove, move, or merge operation. Once the contributor submits the flag, an owner of the half-baked driver thread 514 may approve or deny the request associated with the flag. As such, the owners are granted special privileges that help manage the half-baked driver thread. Similarly, if a contributor 202 submits a flag to merge a collaboration thread in the first stage of maturation with the half-baked driver thread, an owner of the half-baked driver thread may either approve or deny the request. As such, it is clear that the owners of the half-baked driver thread 514 may be able to moderate and manage the half-baked driver thread. Moreover, an owner 204 may be able to merge a collaboration thread 410 from the first stage with the half-baked driver thread 510 owned by the owner 204, request to merge the half-baked driver thread 510 with a key driver thread 610 in the third stage of maturation, or request to merge the half-baked driver thread 510 with another half-baked driver thread 510. Furthermore, the owner may be able to delete the half-baked driver thread 510 or move the half-baked driver thread 510 to a different area of focus within the organization 104.

According to various embodiments such as the embodiment shown in FIG. 5B, graphical representations identifying the one or more contributors 202 of the half-baked driver thread 510 may be presented to the users 102. Similarly, graphical representations identifying the one or more owners 204 of the half-baked driver thread 510 may also be presented to the users 102. According to embodiments, certain half-baked driver threads 510 may only be owned by users 102 that have a specific status or rank within the organization. In addition, existing owners 204 may have the privilege to accept or reject an ownership request of a user 102 requesting to become an owner. Moreover, rules can be placed that define what type of user may become an owner of a collaboration thread. In this way, the group perspective collaboration system 120 may be able to prevent low ranking employees from becoming owners of group perspective threads in sensitive matters. As such, a member of the upper management may be capable of managing the half-baked driver thread, while lower ranked members may be able to contribute to the half-baked driver thread.

Each half-baked driver thread 510 may also include a progress bar or status indicator that indicates the progress of the half-baked driver thread 510. The progress of the half-baked driver thread 510 may be measured by determining the activity associated with the half-baked driver thread 510. Aspects that count towards the activity of the half-baked driver thread 510 include the number of votes received, the number of contributors, the number of owners, the rank of the contributors and the owners, the number of views of the half-baked driver thread 510, the quality of the contributions provided to the half-baked driver thread 510, and the like. The group perspective collaboration system 120 may be configured to determine the progress of the half-baked driver thread 510 based on specific algorithms that incorporate one or more of the aspects listed above.

In various embodiments, the half-baked driver thread 510 may not evolve to the third stage of maturation until the half-baked driver thread 510 meets a second stage maturation threshold level. In FIGS. 5A and 5B, the progress of the half-baked driver thread 510 towards the second stage maturation threshold level is represented by the progress bar described above and shown in FIGS. 5A-5B. When the progress bar reaches a threshold value, which may be a maximum value, the half-baked driver thread 510 may be elevated to the third stage of maturation. At this instance, an owner 204 of the half-baked driver thread 510 may elevate the half-baked driver thread 510 to the third stage of maturation. In some embodiments, the group-perspective collaboration system 120 may automatically elevate the half-baked driver thread 510 to the third stage of maturation once the progress bar reaches the threshold value. In various embodiments, the group-perspective collaboration system 120 may be configured to notify owners of the half-baked driver thread via email or as a notification in their feed that the progress bar has reached the threshold value.

In various embodiments, an owner 204 may request to elevate the half-baked driver thread 510 to the third stage of maturation after the progress bar reaches a threshold value. Upon receiving the request from the owner 204, the group-perspective collaboration system 120 may be configured to present, to the user, a list of existing key driver threads that may be similar to the half-baked driver thread being elevated. The owner 204 may then determine whether any of the existing key driver threads are similar, and if so, submit a request to merge the half-baked driver thread with the appropriate key driver thread. The owner of the key driver thread may then either accept or reject the request to merge.

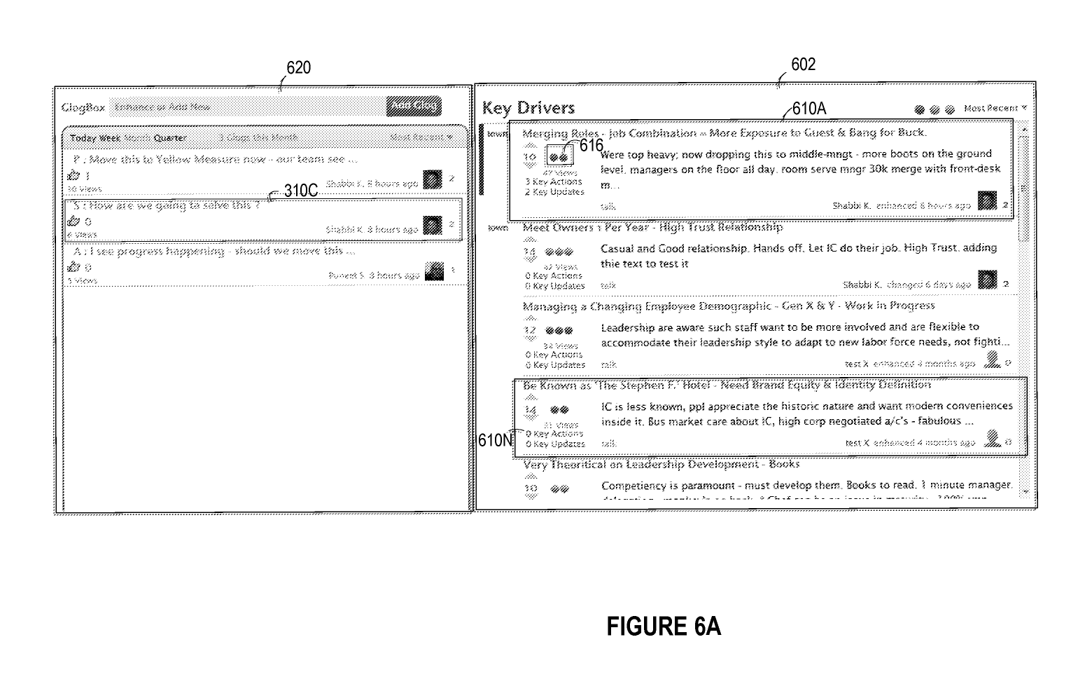

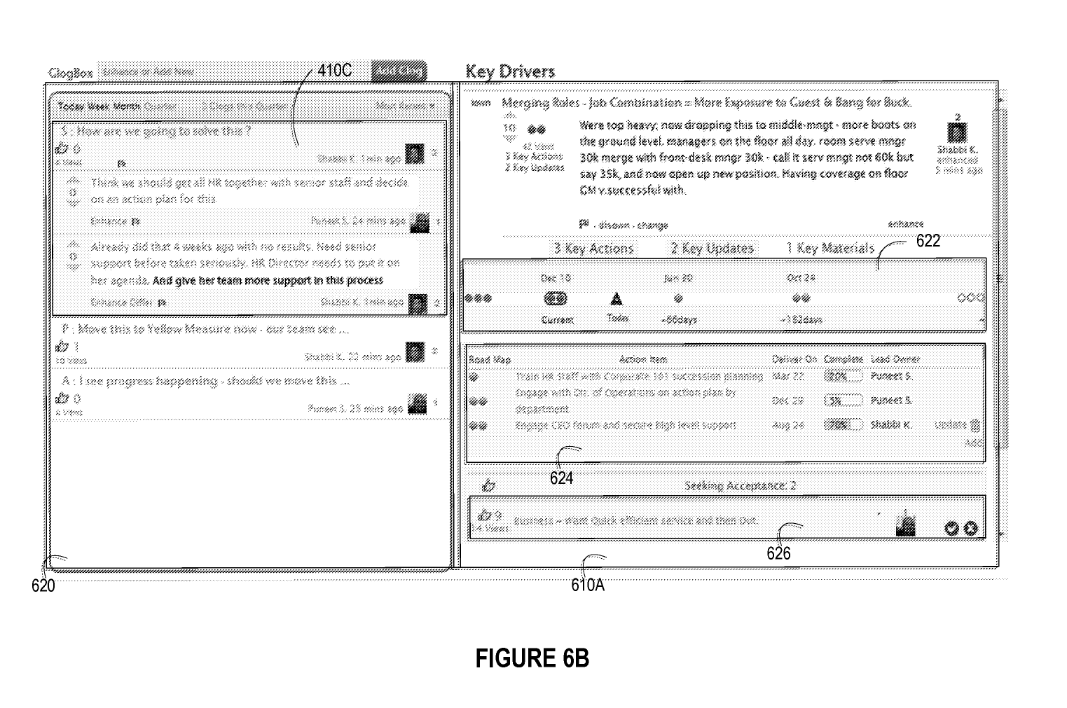

However, if the owner 204 determines that none of the key driver threads is similar to the half-baked driver thread, the owner may submit a request to elevate the half-baked driver thread as a new key driver thread, upon which the group-perspective collaboration system 120 may create a new key driver thread in a key driver thread feed (shown in FIG. 6A) and remove the half-baked driver thread from the half-baked driver thread feed 502.

This exercise of searching for similar key driver threads and merging the half-baked driver thread with an existing similar key driver thread during the elevation process is aimed to reduce the creation of duplicate key drivers, and to encourage users to strengthen the quality of existing key drivers. Through the search and merge process, users may be able to avoid creating repeat key drivers, resulting in a group-perspective collaboration system 120 that provides unique key drivers.

It should be appreciated that in some embodiments, a half-baked driver thread 510 may be elevated to the third stage of maturation without reaching a corresponding maturation threshold level if the half-baked driver thread 510 is merged with a key driver thread 610 already existing in the third stage of maturation. According to various embodiments, an owner 204 of the half-baked driver thread 510 may submit a request to merge a description 514 within the half-baked driver thread 510 or the entire half-baked driver thread 510 with an existing key driver thread 610. In some embodiments, the owner 204 of the half-baked driver thread 510 may also submit a reason for the merge such that the owner of the key driver thread 610 may understand why the owner of the half-baked driver thread requested the merge. The group-perspective collaboration system 120 may then forward the merge request to the owners 204 of the corresponding key driver thread 610, who then may either approve or deny the merge request. If the owners 204 of the key driver thread 610 approve the merge request, the half-baked driver thread 510 may be merged with the key driver thread 610. Details regarding the merge process will be provided during a discussion of the merge module 850, shown in FIG. 8. If the owners 204 of the key driver thread 610 deny the merge request, the owners 204 of the half-baked driver thread 510 may be notified.

According to some embodiments, users 102 may be able to request that contents within a half-baked driver thread 510A or the half-baked driver thread 510A itself be merged with another existing half-baked driver thread, such as the half-baked driver thread 510N. Once a user 102 submits a request, an owner of the half-baked driver thread 510A may approve of the merge request. The group-perspective collaboration system 120 may then notify the owners 204 of the other half-baked driver thread 510N about the merge request. If the owners 204 of the other half-baked driver thread 510N approve the merge request, the merge request is executed. Details regarding the execution of the merge request will be provided during a discussion of the merge module 850, shown in FIG. 8.

Referring now to FIGS. 6A and 6B, an enlarged view of a screenshot illustrating features of the third stage of maturation of the three stage maturation process is shown. As described above, the group-perspective collaboration system 120 may be configured to allow a group of users identify key drivers that drive continuous high performance within an organization. The process of identifying key drivers begins at the first stage of maturation, where a user submits an original lead perspective. After much collaboration amongst the group of users, a half-baked driver thread derived from the original lead perspective is mature enough to be elevated to the third stage of maturation as a key driver thread.

The key driver thread, at the onset, is a mature half-baked driver. However, over time and through a series of contributions made by owners and contributors, the key driver thread continues to evolve and continues to drive continuous high performance within the organization. The key driver thread may be a sophisticated, ever-evolving thread that may have specific rules and features that provide valuable insight about the key drivers. Details regarding the specific rules and features are presented below during a discussion of the screenshots shown in FIGS. 6A and 6B.

In FIGS. 6A and 6B, a key driver thread feed 602 may include key driver threads, such as the key driver threads 610A and 610N. The key driver threads 610 may include content that describe or define key drivers that drive continuous high performance within the organization. As described herein, these key drivers may be derived through a group collaboration process that begins with an individual perspective being discussed by the group of users to form a group perspective, elevating the group perspective through various stages of maturation, and converging similar group perspectives with one another to avoid having multiple key driver threads containing the same key drivers.

According to embodiments, each key driver thread may be owned by one or more owners 204 that owned the half-baked driver thread from which the key driver thread evolved. These owners may have special privileges to manage and moderate the key driver thread 610. In addition, the owners may be responsible for managing a vision 622 of the key driver thread.

Referring now to FIG. 6A, a condensed view of the key driver thread feed 602 is shown. In the condensed view, some information pertaining to each of the key driver threads 610 may be presented to the users 102. For instance, in regard to the key driver thread 610A, the key driver thread feed 602 may display a title of the key driver thread 610, a description associated with the key driver thread, a stamp indicating a time when the last activity was made and the owner involved in the activity, a total number of votes associated with the key driver thread, a total number of views, a number of key actions and a number of key updates associated with the key driver thread, and a performance measurement score 616 representing the owners' perspective on the performance of the key driver in its current state. In various embodiments, the performance measurement score may be represented using a tri-color, five point scale. In one embodiment, the scores from lowest to highest are 3 red, 2 red, 1 orange, 2 green, and 3 green. This simple and clear scoring representation allows owners to gauge the current performance of a key driver in a simple yet meaningful manner. In various embodiments, the colors, number of points, designs of the points, and the like, may vary. In some embodiments, the owners may have defined a vision 622 of the key driver thread, which is discussed below with respect to FIG. 2.

Referring now also to FIG. 6B, an enlarged view of a particular key driver thread 610A is shown. The vision 622 of the key driver thread may be manifested in a timeline-based performance measurement scoring system. The vision 622 of the key driver thread allows the owners to share their perception of the performance of the key driver thread with the group of users over time. In some embodiments, the owners may assign a performance measurement score to one or more stages of evolution of the key driver thread. These stages of evolution may be based on specific actions being taken with respect to the key driver thread. For instance, if two weeks from now, the owners take a key action on the key driver thread, the owners may expect an improvement in the performance of the particular area of focus within the organization. As such, the vision 622 of the key driver thread may reflect an increase in the performance measurement score two weeks from today to reflect the improvement in the performance of the key driver thread once the key action is taken.

As described above, the owners may be able to define key actions in the list of key actions. The owners may be able to assign a performance measurement score to each of the key actions. The performance measurement score indicates the owner's perception of the performance of the key driver thread once the associated key action has been implemented by the owners. In some embodiments, the owners may indicate a delivery date, which indicates the date at which the key action may be implemented. Furthermore, the owners may be able to include a progress bar indicating the progress of the key action for users so that the users can better evaluate the effects of the key actions based on the progress of the key action.

It should be appreciated that the vision 622 of the key driver thread may automatically be updated to reflect the performance measurement score associated with the key action on the associated delivery date. In other embodiments, the owners may manually update the vision 622 of the key driver thread upon completing the key action. Furthermore, the owners may be able to change the performance measurement score for each action at any time based on the owners' perception of the performance of the key driver thread. For instance, if the key action being implemented is well received by the users and the results are above the owner's expectations, the owner may be able to update the performance measurement score for the key action, as well as modify the performance measurement scores for previous, concurrent, and subsequent key actions. In addition, the owner may be able to modify the vision of the key driver thread to indicate to the users of the group, the owner's new perception of the performance of the key driver. The vision and the individual performance measurement scores for each of the key actions may be discussed by the group of users and feedback supporting or disagreeing with the vision or the performance measurement scores may be provided to the owners.

In various embodiments of the present disclosure, the key driver thread may also include a discussion box 620 similar to the discussion box 520 of the half-baked driver thread 510. The discussion box 620 may be accessible by the owners and the contributors for the key driver thread and may be a forum where the contributors and owners may discuss various aspects of the key driver thread. Users may be able to submit original lead perspectives, which become collaboration threads and/or half-baked driver threads. In addition, users may be able to vote for or against particular threads in a manner similar to that described in FIGS. 4, 5A and 5B.

Contributors or owners may request to merge content from the various threads in the discussion box and elsewhere with the key driver thread. To do so, the contributors or owners may submit a request to merge the content within the various threads, upon which the content may appear as a key update in the key update list of the key driver thread. Owners of the key driver thread may either accept or reject the key updates. However, even if the key update is rejected by the owners, the owners were able to access the merge request, which in itself, provides value to the discussion between the owners and the contributors. If the owners accept the key update, the owners may be able to add the key update as a key action in the key action list 624, as described above. Additionally or alternatively, if one of the owners determines that the update is relevant to a current or vision aspect of the key driver, the owner can merge the key update into the current or vision aspects of the key driver.

As described above, the discussion box 620 may be used as a forum for users of the group to share their perspectives with one another. In essence, the discussion box 620 is a dedicated forum where contributors and owners may develop contribution threads and half-baked driver threads corresponding to the associated key driver thread. As owners take key actions based on the key driver thread, the contributors may be able to provide valuable feedback through the discussion box 620. Other contributors may also chime in with their contributions in the form of directed amendments, votes, or flags. As such, the discussion box allows the contributors to form group perspectives, which may then be presented to the owners by submitting a merge request with the key driver thread. In this way, the owners are able to receive substantive feedback that may have been vetted through the first two stages of maturation. It should be appreciated that contributors may submit requests to merge collaboration threads with the key driver threads, although, in some embodiments, such requests to merge may be discouraged until the collaboration thread evolves to a half-baked thread.

As briefly mentioned above, the key driver thread 610A may include key actions 624 to be implemented to deliver continuous high performance within the organization. In an example embodiment and for the sake of explanation, let us assume that the group of users derived a key driver of a particular area of focus within an organization to be “improving employee commissions for sales over $200.” In the key driver thread, owners of the key driver thread may contribute to the key driver thread by suggesting ways to improve employee commissions for sales over $200. Moreover, an owner may submit a key action, such as “provide $20 cash reward to employees for sales over $200.” The owner may then implement the action in real life, such that employees who have sales over $200 receive a $20 cash reward. Once the owner implements this action in reality, the employees may be able to provide feedback to the owners through the group perspective collaboration system 120. The employees, as contributors 202, may be able to submit their feedback to the owners regarding the particular action by discussing the action within discussion box 620 of the key driver thread. In this way, the owner may know the effect of the key action taken by the owner. Upon receiving the feedback, the owner may adjust the key actions taken based on the feedback received. As a result, the contributors 202 and the owners 204 of the key driver thread are capable of communicating through the group perspective collaboration system 120 about the key driver in general, and specifically, about key actions and effects of the key actions associated with the key driver.

Contributors of collaboration threads 410 or owners of half-baked driver threads 510 may be configured to submit requests to merge the respective threads 410 or 510 as a key update if the contributor or owner believes their corresponding thread is related to the key driver thread 610. In this way, noise may be reduced and owners of the key driver thread 610 may be updated about a new and relevant topic that is relevant to the key driver. As a result, the quality of the key driver thread 610 may increase. In some embodiments, if the corresponding thread is accepted as a key update to the key driver thread 610, the owners of the corresponding thread may also become owners of the key driver thread 610.

It should be appreciated that the vision 622 of the key driver thread 610 may automatically update the current performance measurement score of the key driver as the delivery dates of key actions arrive. In alternate embodiments, the owners may manually have to update the performance measurement score of the key driver as key actions are executed. In either situation, once the owner updates the performance measurement score of the key driver, contributors of the key driver thread may be able to discuss the score assigned by the owner. In this way, the contributors may be able to keep the owner accountable for his perceptions of the performance of the key driver. As a result, the owners may be able to receive information from the contributors, thereby allowing the owners to get a better understanding of the key driver based on the perspectives of the contributors.

In some embodiments, the owners of the key driver thread may alter the vision at any time. For instance, if the owner believes that the key driver's performance has improved, the owner may raise the performance measurement score of the current state. Similarly, if the owner believes that the key driver's performance has become worse, the owner may lower the performance measurement score of the current state. As owners can alter the performance measurement indicator at any time based on the performance of executed key actions or based on feedback received from the contributors, the group-perspective collaboration system 120 may be configured to refresh the roadmap and list of key actions each time a date change occurs.

In addition, the key driver thread 610 may also include key updates that include key updates submitted by contributors and owners. In some embodiments, contributors may submit perspectives as collaboration threads 410, while owners may be able to submit perspectives as half-baked driver threads. An owner of the key driver thread may either accept or reject the key updates submitted by the contributors. If the owner accepts the key update, the owner may create key action based on the accepted key update. Alternatively, the key update may be merged with the description of the key driver thread. As described above, only owners may contribute to the key driver thread directly, while contributors may be able to contribute to the key driver thread by elevating a perspective through the first two stages of the maturation process.

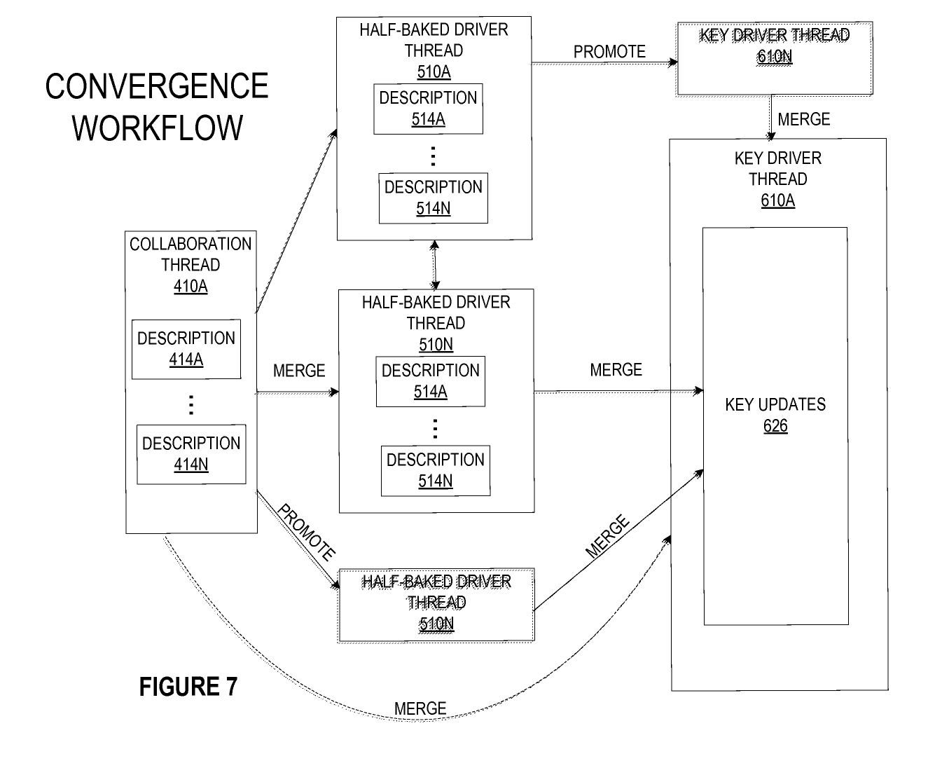

FIG. 7 is a workflow diagram illustrating a convergence mechanism between the three stages of maturation according to one or more embodiments presented herein. In particular, one of the features of the group-perspective collaboration system 120 is the ability to converge perspectives in an attempt to reduce the amount of digital noise produced by repeated content. As shown in the workflow diagram, a collaboration thread 410A or one or more descriptions, such as descriptions 414A, 414N, within the collaboration thread 410A may be elevated from the first stage of maturation to the second stage of maturation by merging with an existing half-baked driver thread, such as the half-baked driver threads 510A, 510B or by being promoted to a new half-baked driver thread, such as the half-baked driver thread 510N. The collaboration thread 410A or one or more of the descriptions 414A, 414N may also be elevated from the first stage of maturation to the third stage of maturation by merging with a key driver thread, such as the key driver thread 610A.

Similarly, a half-baked driver thread, such as the half-baked driver thread 510A, or content, such as the descriptions 514A, 514N within the half-baked driver thread 510A may merge with another half-baked driver thread 510B or with a key driver thread, such as the key driver thread 610A. According to embodiments, a contributor may submit a request to merge a particular description within the half-baked driver thread or the entire half-baked driver thread itself with another half-baked driver thread or key driver thread. In some embodiments, the contributor may submit a reason for the merge request to help the owners understand the contributor's perspective on the merge request. In some embodiments, only owners of the half-baked thread may be configured to submit merge requests. Once the contributor submits the request, the group-perspective collaboration system 120 may present the request to an owner of the half-baked driver thread. If the owner of the half-baked merge request denies the merge request, the merge request is canceled. However, if the owner of the half-baked driver thread approves the merge request, the group-perspective collaboration system 120 may forward the merge request to the owners of the half-baked driver thread or the key driver thread with which the merge is requested. There, if the owners of the half-baked driver thread or the key driver thread reject the merge request, the merge request is canceled. However, if the owners of the half-baked driver thread or the key driver thread approve the merge request, the merge request is executed. In various embodiments, the merge request may be executed once the owner of the half-baked driver thread that is being merged accepts the merge request. In some embodiments, the owner of the half-baked driver thread may also be configured to submit a reason for accepting a merge request, which may then be presented as a notification in the feeds of various users.

If the merge request involves a description being merged with another half-baked driver thread, the description is simply included within the half-baked driver thread and the votes corresponding to the description are carried to the half-baked driver thread. In some embodiments, these votes may be added to the total number of votes of the half-baked driver thread. In alternate embodiments, the votes of the description may not be added to the total number of votes of the half-baked driver thread.

If the merge request involves a half-baked driver thread merging with another half-baked driver thread, then one more the half-baked driver threads may become a primary half-baked driver thread, while the contents of a secondary half-baked driver thread may be imported within the primary half-baked driver thread. In addition, attributes, such as the total number of votes and the votes corresponding to each of the descriptions from the secondary half-baked driver thread may or may not be counted towards the total votes of the primary half-baked driver thread. Once a secondary half-baked driver thread or a description corresponding to a half-baked driver thread has been merged with the primary half-baked driver thread, the secondary half-baked driver thread or the description that has been merged may no longer be visible to the users.

If the merge request involves a half-baked driver thread merging with another key driver thread, such as the key driver thread 610, the contents of the half-baked driver thread may be placed within the key update list of the key driver thread awaiting action from the owners of the key driver thread, while the half-baked driver thread may no longer be visible to the users as a half-baked driver thread.

Furthermore, a half-baked driver thread, such as the half-baked driver thread 510A, or the contents within the half-baked driver thread 510 may be promoted to the third stage of maturation as a key driver thread, such as the key driver thread 610N. According to embodiments, the process of promoting a half-baked driver thread to a key driver thread may involve satisfying certain requirements, which are described above. Once the half-baked driver thread has met the requirements, the half-baked driver thread may be elevated to the third stage of maturation, where it becomes a key driver thread and the half-baked driver thread from which the key driver thread evolved may no longer be visible to the users.

In addition, a key driver thread may be merged with another key driver thread in a manner similar to how two half-baked driver threads may be merged. A specific predefined set of rules may determine which of the key driver threads will be the primary key driver thread and the secondary key driver thread. After the merger is complete, the secondary key driver thread may no longer be visible to the users. According to embodiments, some of the criteria used in determining which of the key driver threads will be the primary key driver thread include, but are not limited to, the number of owners, the number of key actions, the current performance measurement score, the vision, the number of contributors, the number of views, the number of contributions, the quality of the contributions, the quality of the key actions, and the like.

Referring now to FIG. 8, a block diagram illustrating aspects of the group perspective collaboration application 802 is shown. The group perspective collaboration application 802 may include computer-executable instructions or code, which, when executed by a computer, may cause the group perspective collaboration system 120 to provide a platform for users to deliver continuous high performance. According to embodiments, the group perspective collaboration application 802 may include one or more modules that include computer-executable instructions that may be executed by a computer. Additional details related to these modules are presented below.

The group perspective collaboration application 802 may include a user database module 810 that is configured to manage details pertaining to the one or more users using the group perspective collaboration system 120. According to embodiments, the user database module 810 may be configured to authenticate users, manage user accounts associated with the users, manage permissions associated with the user accounts, including assigning permissions that enable a user to operate as a contributor and/or an owner. In addition, the user database module 810 may be configured to limit access of the user to those areas of the group perspective collaboration system 120 to which the user is authorized access. For instance, in a corporate setting, lower-level employees may have limited access to higher-level area of focuses. Similarly, employees of a particular area of focus, such as account services, may not be able to access the human resources area of focus, and vice versa.

The group perspective collaboration application 802 may also include a collaboration thread module 820. The collaboration thread module 820 may be configured to receive an original lead perspective from a user 102 of the group. In some embodiments, the user 102 may submit hash tags along with the original lead perspective to help match the original lead perspective with other group perspective threads. It should be appreciated that a user may be able to select pre-defined hash tags such that collaboration threads containing similar hash-tags may be easily searched and retrieved.

According to embodiments, when a user submits a title, the group perspective collaboration system 120 may conduct a key-word or semantic search to determine if a group perspective thread that is similar to the original lead perspective exists. The group perspective collaboration system 120 may present one or more group perspective threads that contain content that is similar to the user's submission to the user. The user 102 may then select one of the group perspective threads presented in the search results. However, if the user 102 desires to create a new group perspective thread, the user may request to add a new group perspective thread. The collaboration thread module 820 may then generate a collaboration thread 410 that includes the original perspective submitted by the user 102.

According to embodiments, the collaboration thread module 820 may further be configured to allow contributors 202 to refine the collaboration thread. In some embodiments, a contributor 202 may enhance the collaboration thread by amending the description 414A with the contributor's own perspective. However, if the contributor 202 has a differing perspective that differs from the original description, the contributor 202 may submit his or her differing perspective as a separate description 414B. Additional contributors 202 may also refine the collaboration thread 410A by either enhancing existing descriptions 414A, 414B or submitting a separate description 414N containing a differing perspective.

In some embodiments, the group perspective collaboration system 120 may limit the number of descriptions containing differing perspectives within a collaboration thread 410 in an effort to reduce the noise generated by less relevant differing perspectives. This also allows users to focus on contributing to and enhancing the original lead perspective. For instance, in one embodiment, the group perspective collaboration system 120 limits the number of differing descriptions to two. Furthermore, in some embodiments, the group perspective collaboration system 120 may allow the user to set the maximum number of differing descriptions allowable for the corresponding collaboration thread.

The collaboration thread module 820 may also be configured to provide and manage other features of the collaboration thread. In particular, the collaboration thread module 820 may provide users the ability to vote for or against a particular description contained within the collaboration thread, or vote for or against an entire collaboration thread. The collaboration thread module 820 may be configured to monitor the number of votes and present them to the users. In addition, the collaboration thread module 820 may be able to display the number of views of a particular collaboration thread. The number of votes and views may be useful for users to identify which collaboration threads are important or relevant to the group of users.

The collaboration thread module 820 may also be configured to provide the contributors 202 an option to flag the collaboration thread 410 or any of the descriptions contained within the collaboration thread 410. A contributor 202 may flag the collaboration thread 410 or any of the descriptions contained within the collaboration thread 410 for removal, for moving to a different area of focus, or merging with another collaboration thread, a half-baked driver thread or key driver thread. This allows users to self-monitor the collaboration threads 410 and to remove redundant collaboration threads or descriptions. Since users posting an original lead perspective may be able to select the area of focus in which the collaboration thread 410 is posted, often times the collaboration thread 410 may be enhanced by contributors 202 in such a manner that the area of focus selected by the contributor 202 posting the original perspective no longer remains the most appropriate area of focus. As such, contributors 202 may be able to flag the collaboration thread 410 to move the collaboration thread 410 to a more appropriate area of focus. Moreover, one of the contributors 202 may be able to flag the collaboration thread 410 for merging the collaboration thread 410 with another collaboration thread 410, a half-baked driver thread 510 or a key driver thread 610. In such cases, the contributors 202 may need to specify which group perspective thread to merge the collaboration thread 410 with and may also specify a reason for the merge. In this way, the owner 204 of a half-baked driver thread 510 or a key driver thread 610 may be better informed in regard to why the merge request was made.

The group perspective collaboration application 802 may further include a half-baked driver thread module 830 that is configured to perform functions associated with the half-baked driver threads 510. In particular, the half-baked driver thread module 830 may be configured to manage the half-baked driver threads 510. This may include adding, removing, moving and merging the half-baked driver threads 510. In addition, the half-baked driver thread module 830 may be configured to receive requests from contributors 202 to become owners 204 of the half-baked driver threads 510. In this regard, the half-baked driver thread module 830 may be configured to assign ownership rights to the owners 204 and restrict users that are not owners 204 of the half-baked driver thread module 830 from performing specific operations. For instance, in the half-baked driver threads 510, only owners 204 may be able to approve or reject merge requests. Furthermore, only owners may be able to promote the half-baked driver thread 510 to the third stage of maturation as a new key driver thread 610. It should be appreciated that the half-baked driver thread module 830 is not limited to only performing those functions that are associated with the half-baked driver threads 510 as described herein, but may also be configured to perform additional functions associated with the half-baked driver threads.

The group perspective collaboration application 802 may further include a key driver thread module 840 that is configured to perform functions associated with the key driver threads 610. In particular, the key driver thread module 840 may be configured to manage the key driver threads 610, including managing the key action list 624, the key updates list 626, and the key materials list. In addition, the key driver thread module 840 may also be configured to implement actions taken by the owners 204 of the key driver threads 610.

Furthermore, the key driver thread module 840 may be able to assign specific users of the group perspective collaboration system 120 mentorship rights, which allow the specific users to act as mentors. As described above, mentors may approve or decline requests made by owners of the key driver threads 610. According to embodiments, owners may submit flags to request merging a key driver thread with another key driver thread. Mentors may then approve or reject the merge requests. In addition, mentors may be afforded special privileges to remove, move, and merge contents within a thread or threads itself from any stage of the three stage maturation process.

It should be appreciated that the key driver thread module 840 is not limited to only performing those functions that are associated with the key driver threads 610 as described herein, but may also be configured to perform additional functions associated with the key driver threads.

In various embodiments, the group perspective collaboration application 802 may also include a merge module 850 that may be configured to execute merge requests. As described in FIG. 7, the various threads and the content contained in the threads may be merged between the three stages of maturation. Furthermore, each stage of maturation may have different rules regarding executing a merge request. As such, a merge module may be configured to execute merge requests. It should be appreciated that during a merge operation, the group-perspective collaboration system 120 may be configured to search for similar threads and present the search results to the user requesting the merge operation.

In various embodiments, the group perspective collaboration application 802 may also include an interactive feed module 860 that presents an interactive feed to users of the group perspective collaboration system 120. As shown in FIGS. 4, 5, and 6, an interactive feed may be a collaboration thread feed 402, a half-baked driver thread feed 402, or a key driver thread feed 602. It may also be a feed that includes all types of group perspective threads. According to embodiments, an interactive feed may be configured to provide users a list of one or more group perspective threads with which the user 102 can interact directly without having to access the particular group perspective thread separately. In this way, a user 102 may contribute to a particular group perspective thread within the interactive feed without having to first access the group perspective thread in a separate window dedicated to the group perspective thread.

Furthermore, the interactive feed module 860 may be configured to provide a user the option to broadcast a contribution to a group perspective thread to other user's interactive feeds. In this way, the user may avoid flooding other user's feeds by electing to not broadcast contributions that involve minor amendments or insignificant changes made to a group perspective thread. In addition, the interactive feed module 860 may allow the user to filter the type of group perspective threads to display in their own interactive feed, as well as filter updates made to a type of group perspective thread based on the type and extent of contributions made to the group perspective thread by other users. Additional filters may be utilized to only show activities associated with a particular area of focus, a particular hash tag, a particular user, or a particular sub-group of users, amongst others. In addition, the interactive feed module may be configured to display an individual feed that includes only those group perspective threads with which the user is associated, or an area of focus feed that includes group perspective threads associated with a particular area of focus.

The group perspective collaboration application 802 may also include a leadership message ribbon module 870 that is configured to manage the leadership message ribbon 306 displayed on the header portion 300 of the user interface. As described above, the leadership message ribbon 306 may be utilized to broadcast messages to the users of the group perspective collaboration system 120. As such, only messages that are worthy of being broadcast to the users may be selected for broadcast. In various embodiments, senior users with authority may be allowed to broadcast messages through the leadership message ribbon 306. In addition, other users may be able to present messages through the leadership message ribbon 306 based on performance, earned rewards, and the like.

According to embodiments, a user may desire to broadcast a message on the leadership message ribbon module 870 of one or more users of the group. For instance, a user who is a part of the human resources department may choose to broadcast the message only to users who are a part of the human resources department. As such, if the user has the authority to broadcast messages to the human resources department, the user may submit a request to the leadership message ribbon module 870. According to embodiments, the request may include a message with a maximum character limit, a frequency at which to broadcast the message, a time frame within which to broadcast the message, specific users or types of users to whom the message is to be broadcasted, and other reasonable parameters. The leadership message ribbon module 870 may then process the request taking into account the parameters submitted by the user, and present the broadcast message submitted by the user to the group of users identified in the request. In further embodiments, the leadership message ribbon module 870 may be able to prioritize the requests based on the seniority of the user submitting the request, the importance or priority level of the request, or any other reasonable prioritization factor.

The group perspective collaboration application 802 may further include a real-time group enhancement module 880 that is configured to allow multiple users to collaborate real-time. According to embodiments, the users may communicate with one another using a real-time communications client that is configured to allow each of the users to participate in a real-time online conversation. For instance, using the real-time group enhancement module 880, the group of users may collaboratively enhance a group perspective thread. According to some embodiments, one of the users of the group may be designated as the editor, while the other users may be observers. The group of users may be able to view the group perspective thread to be enhanced, as well as view a separate conversation window in which the group of users can communicate in real-time. Only the editor may edit the text in the group perspective thread. However, any of the group of users, including the editor and the observers, may be able to communicate with the other users of the group via the conversation window. It should be appreciated that the conversation window may include any type of real-time communication, such as text, audio, video, or any combination thereof. In this way, the observers may be able to comment on the edits made to the group perspective thread while the editor is making revisions. In some embodiments, the editor may be able to delegate the editing duties to another user of the group, in which situation, the delegated user becomes the editor and the previous editor becomes an observer. According to an example embodiment, an icon, such as a pen symbol, may indicate the editor of the group-enhancement entity. By way of the group enhancement module 880, the group of users may accelerate the process of arriving at a group perspective as this allows for a group of users to participate collectively in real time.

The group-perspective collaboration application 802 may also include a search analysis module 890 that may be configured to perform a semantic analysis of information patterns in the group-perspective collaboration system 120 so that the group-perspective collaboration system 120 may automatically suggest repetitive or similar threads. This empowers and accelerates users to achieve high quality zero-repeat key drivers, which may allow the group-perspective collaboration system 120 to derive mutually exclusive but collectively exhaustible set of key drivers of performance for the organization.

Other features that may be included within the group-perspective collaboration application 802 may include blocking multiple contributors from contributing to the same description simultaneously. By doing so, the contributors are forced to wait to receive another contributor's perspective before providing their own. As a result, the group-perspective collaboration system 120 locks out other contributors from contributing while a contributor has control of the group-perspective thread. This helps reduce the digital noise that may be produced if both the contributors were contributing the same perspective simultaneously as well as forces subsequent users to build upon the perspectives submitted by preceding users. Since only one contributor may contribute to a description at any given time, the group-perspective collaboration system 120 may implement a timer that limits the amount of time a contributor has to submit a perspective. In this way, the group-perspective collaboration system 120 can provide a dynamic collaboration system which reduces the amount of digital noise that may be generated by a large group of users.

Moreover, the group-perspective collaboration application 802 may be configured to provide functionality to reduce the amount of digital information shown to the group of users. For instance, in one embodiment, a user may request to see the evolution of a description or a group-perspective thread over a specific time frame. In one example, if the user clicks a time stamp associated with a contribution made to a description, such as description 414 or 514, the group-perspective collaboration application 802 may display all the contributions made to the particular description. However, the group-perspective collaboration application 802 may be configured to allow the user to select the level of granularity at which the various contributions are shown. In some embodiments, the granularity may be time based, such that only contributions made within a certain time frame are shown. In other embodiments, the granularity may be based on the type of contribution made to the description. For instance, one level of granularity may display only major amendments made to the description, which may include adding or removing 10 characters or more. Another level of granularity may display only edits made to the description regardless of a character length. Another level of granularity may display both edits made to the description as well as when specific votes were cast. In this way, the user may be able to determine both the progression of a particular description as well as various trends associated with the description.

The group perspective collaboration application 802 may also include a thread performance analysis module 892 that is configured to analyze the key drivers. In some embodiments, aspects such as measurement, content, actions, contributions, level of activity, and the like may be analyzed. The key drivers may then be compared with other similar key drivers that exist within other organizations using the group-perspective collaboration system 120. Similar key drivers across organizations may be identified through semantic analysis, similar to the methodologies utilized by the search analysis module 890. An eco-system of key drivers may be compared and analyzed to share best practices, benchmark, amongst others in an attempt to improve the key drivers by utilizing the contributions generated within organizations.

In addition, the group-perspective collaboration application 802 may also include an incentive rewards module 894 that is configured to implement an incentive rewards program that incentivizes contributors and owners to collaborate. Points may be awarded for various types of activities, such as taking ownership of a group-perspective thread, submitting a collaboration thread, voting for or against a group perspective thread, submitting flag requests, making decisions on flag requests, taking actions as owners, providing feedback as contributors, and the like. In addition, points may be awarded for reaching certain milestones, such as 100^{th} contribution, or 10^{th} vote, or 5^{th} ownership goal. In addition, points may be redeemable to unlock specific responsibilities that were otherwise not available. It should be appreciated that other commonly known incentive rewards may be utilized to help increase participation.

In some embodiments, users are rewarded based on their behavior and level of activity in the group-perspective collaboration system 120. Users may be able to accumulate points which will count to a total user score used to assign rewards. In some embodiments, rewards may be in the form of badges or other artifacts in the system. In addition, the points may be redeemed for additional capabilities, such as being provided owner rights, or the ability to post messages on the leadership ribbon. In some embodiments, rewards may be earned or lost based on contributions and the quality of contributions. In some instances, a user may earn rewards if another user votes in favor of their contribution and may lose reward points if their contribution is voted down. A contribution may include an original perspective or a perspective that differs from the original perspective, or any other contribution submitted by the user. In some embodiments, the incentive rewards program 894 may implement rules in which a user may need to earn rewards to perform certain operations. For example, a user may need to earn a certain number of points by contributing to collaboration threads before the user is allowed to do other operations in the system, such as flagging to merge, remove, or move. Furthermore, badges can be assigned to users who earn points based on certain operations. For example, a “Star Contributor” badge can be given to a user whose contributions consistently gain a lot of votes hence points. In another example, a “Doer” badge can be given to a user who owns and takes a lot of actions.

It should also be appreciated that points assigned can be broken down into categories based on types of operations performed. For example, contribution points (enhance/differ), owner points (own, add action) and clean-up points (flagging, merging, pushing key updates), may have different inherent values and may be redeemable for different types of rewards.

Also, in some embodiments, users can give away points to encourage other users to pay attention to their group-perspective thread 410, 510, or 610 thereby creating an internal market system based on points earned. Senior users can assess junior members based on their points and badges earned. The senior users can issue points for particular operations/behavior require, such as to increase the number and/or quality of contributions in a particular area of focus in the organization.

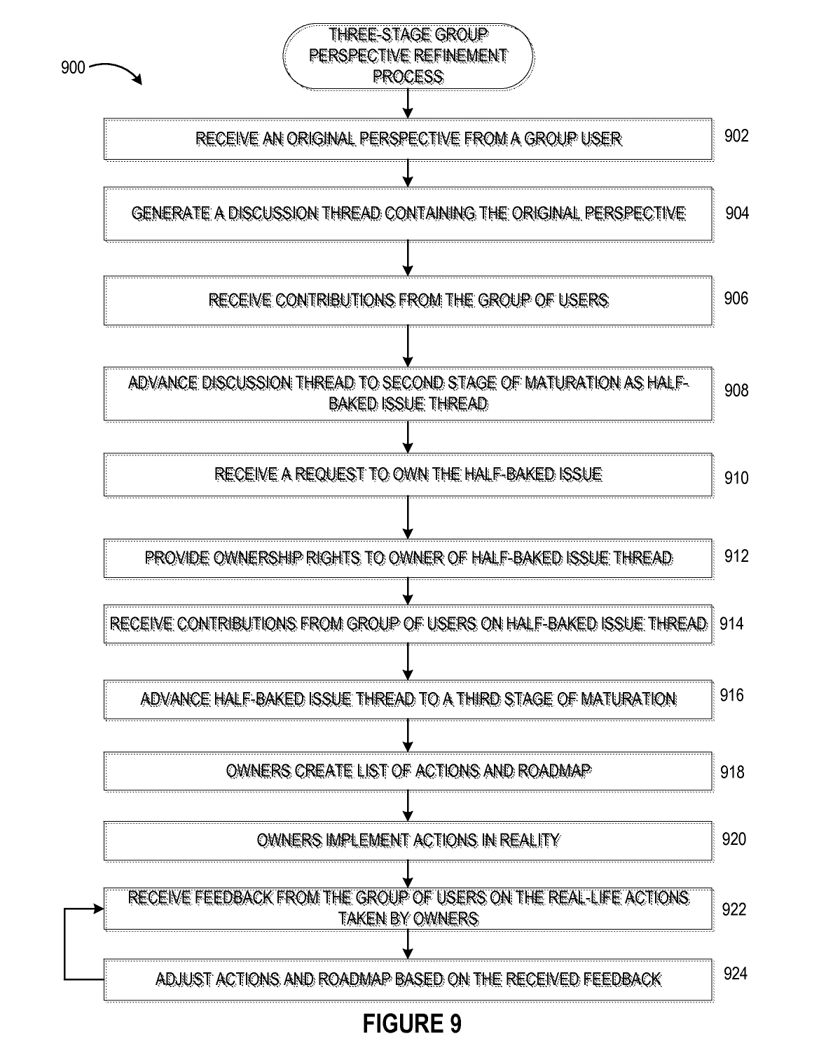

Turning now to FIG. 9, additional details will be provided regarding the embodiments presented herein for delivering continuous high performance using a group perspective collaboration system. In particular, FIG. 9 is a flow diagram flow diagram illustrating aspects of a process for delivering continuous high performance according to one or more embodiments presented herein. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, or any combination thereof. It should also be appreciated that more or fewer operations may be performed than shown in the figures and described herein. These operations may also be performed in parallel, or in a different order than those described herein

The routine 900 begins at operation 902, where the group perspective collaboration system 120 is configured to receive an original perspective from a user 102A of a group of users 102. As described above, the original perspective may be a thought, idea, question, suggestion, answer, or any other expression that the user would like to share with the group of users 102. Upon receiving an original perspective from the user 102, the search analysis module 890 may be configured to search the group perspective collaboration system 120 for existing group perspective threads to see if a similar group perspective thread exists. The search analysis module 890 may then provide the user with similar results. If the user decides to add a new perspective, the collaboration thread module 820 may prompt the user to include a title, such as the title 412 and a description, such as the description 414.

From operation 902, the routine 900 proceeds to operation 904, where the collaboration thread module 820 may generate a collaboration thread 410 that may contain the title 412 and description 414 submitted by the user 102. It should be understood that the user's perspective may be expressed in the title and/or the description. In some embodiments, the original perspective may not be in a text format, but rather in a rich media format. According to embodiments, the collaboration thread 410 may be viewed by other users of the group. In some embodiments, the user may submit an original perspective within a specific area of focus.

From operation 904, the routine 900 proceeds to operation 906, where the group perspective collaboration system 120 may receive one or more contributions from the contributors 202. As described above, a contribution may be in the form of an enhancement of the description 414A, the addition of a differing perspective that is provided as a separate description 414B, or as a vote in favor of or against any of the descriptions 414. In addition, a contributor 202 may contribute to the collaboration thread 410 by flagging it for removal, moving to a different area of focus, or merging it with perspective half-baked driver thread or a key driver thread. A contributor 202 may also submit a request to promote the collaboration thread 410 to the second stage of maturation, where the collaboration thread 410 becomes a half-baked driver thread 510.

From operation 906, the routine 900 proceeds to operation 908, where the collaboration thread module 820 may be configured to promote the collaboration thread 410 to the second stage of maturation, where the collaboration thread 410 becomes a half-baked driver thread 510. As previously described, a contributor 202 may request to promote the collaboration thread 410. In some embodiments, the collaboration thread module 820 may promote the collaboration thread 410 to the second stage of maturation without determining the activity of the collaboration thread 410. This is because the group perspective collaboration system 120 may be designed to allow users to self-monitor the group perspective threads. As such, if another contributor 202 believes the collaboration thread 410 that is elevated to a half-baked driver thread 510 is not mature enough, the contributor 202 may submit a request to remove the half-baked driver thread 510 from the group perspective collaboration system 120 or to move the half-baked driver thread 510 to the first stage of maturation where it again becomes a collaboration thread 410.

From operation 908, the routine 900 proceeds to operation 910, where the half-baked driver thread module 830 may receive an ownership request from a contributor 202 of the group to own the half-baked driver thread. According to embodiments, the half-baked driver thread module 830 may determine whether the contributor 202 has the credentials to become an owner 204. For instance, in some embodiments, only contributors 202 above a certain rank in the organization may become an owner 204 of the half-baked driver thread 510.

From operation 910, the routine 900 proceeds to operation 912, where the half-baked driver thread module 830 may approve the ownership request and provide ownership rights to the contributor 202. In some embodiments, an existing owner of the half-baked driver thread may be able to submit an approval to the half-baked driver thread module, which then executes the ownership request and provides ownership rights to the contributor 202. As discussed above, an owner may be granted special privileges to take decisions regarding the half-baked driver thread 510. For instance, only owners may have the right to approve or reject a merger with another group perspective thread, the right to move the half-baked driver thread 510 to another area of focus, to demote the half-baked driver thread 510 to the first stage of maturation, or to elevate the half-baked driver thread 510 third of stage of maturation.

From operation 912, the routine 900 proceeds to operation 914, where the half-baked driver thread module 830 may receive one or more contributions towards the half-baked driver thread 510. Similar to the contributions made by users to the collaboration thread 410 in the first stage of maturation, the contributions made by users towards the half-baked driver threads 510 may include enhancing existing descriptions, voting for or against specific descriptions, submitting merge requests to merge the half-baked driver thread with another group perspective thread, or submitting a new collaboration thread 410 that may include a contributor's individual perspective.

From operation 914, the routine 900 proceeds to operation 916, where the half-baked driver thread module 830 may be configured to advance the half-baked driver thread 510 to the third stage of maturation as a key driver thread 610. According to embodiments, the half-baked driver thread 510 may only be advanced to the third stage of maturation upon meeting a second stage threshold maturation level or by being merged with a key driver thread. As described above and shown in FIG. 4, a progress bar indicating the progress of a half-baked driver thread 510 towards the second stage threshold maturation level may be displayed to the group of users to indicate the maturation level of the half-baked driver thread 510. It should be appreciated that various factors are utilized to determine the maturation level of a group perspective thread, including but not limited to, the number of contributors, owners, votes, views, the frequency of activity occurring within the group perspective thread, the rank of users, and the like. Once the half-baked driver thread module 830 determines that the half-baked driver thread has met the second stage threshold maturation level, the half-baked driver thread module may elevate the half-baked driver thread to the third stage of maturation as a key driver thread.

From operation 916, the routine 900 proceeds to operation 918, where the key driver thread module 840 receives requests from owners to create key actions. Owners may create key actions that are then presented to the users. To create a key action, an owner may provide a key action to be taken, a delivery date of when the key action will be completed, and a performance measurement score that the key driver thread will achieve through the completion of the key action.

From operation 918, the routine 900 proceeds to operation 920, where the owners may implement the key actions of the key driver thread in reality. What this means is the owners may take specific actions in real-life in an attempt to improve the performance of the organization. Since these key actions are associated with issues that the group of users identifies as key drivers, the implementation of these key actions may result in improving aspects of the organization. In some embodiments, owners may update a vision of improved performance sores that correspond to the actions the owners plan to take. This may be useful since the owners will be able to compare their predicted performance with actual performance after receiving feedback from the users.

From operation 920, the routine 900 proceeds to operation 922, where the group of users may submit feedback on the actions taken by the owners of the key driver thread 610 or feedback on changes made to the roadmap or any other aspect of the key driver thread 610. It should be appreciated that the contributors 202 may submit suggestions on any aspect of the key driver thread, including, but not limited to feedback, new ideas, disagreements, complaints, roadmap performance scores, roadmap updates and the like. According to embodiments, the key driver thread module 840 may be configured to provide a discussion box 620, which serves as a platform where users, including contributors 202 and owners 204 of the group may discuss the actions taken by the owners. In this way, the owners may be able to realize the effects of the actions and the results generated by such actions as well as changes made to the owners roadmap, amongst others.

From operation 922, the routine 900 proceeds to operation 924, where the owners may add new key actions to the key driver thread 610 or modify existing key actions. As described above, the owners may also be able to adjust the vision 622 of the key driver thread 610 based, in part, on the feedback received from the users. In addition, the owners may be able to take real life actions on the new or amended key actions in an attempt to further improve the performance of the organization.

From operation 924, the routine 900 returns to operation 922, where the group of users may submit feedback on the subsequent actions taken by the owners of the key driver thread. In this way, a continuous feedback loop is created and the group of users, as owners and contributors, may be able to deliver continuous high performance to the organization by taking actions on key driver issues that are identified by the group of users as the key drivers that drive the performance of the organization.

It should be appreciated by those skilled in the art that the owners have the ability to alter the vision of the key driver thread. The vision of the key driver thread may include a performance measurement score for the current state of the key driver thread, as well as future states of the key driver thread. Since the vision of the key driver thread is based on the perspective of an owner, the vision is merely subjective. As a result, the owner may alter the vision of the key driver thread based on feedback received from the contributors as well as based on any new information received by the owner. When the owner adjusts the vision based on a particular key action, the contributors may be able to provide feedback indicating their thoughts on the adjustments made to the vision. In this way, the owners are kept accountable and informed about their perceptions. As a result, the owners are able to get closer to a true reality by utilizing group perspectives submitted by the group of users.

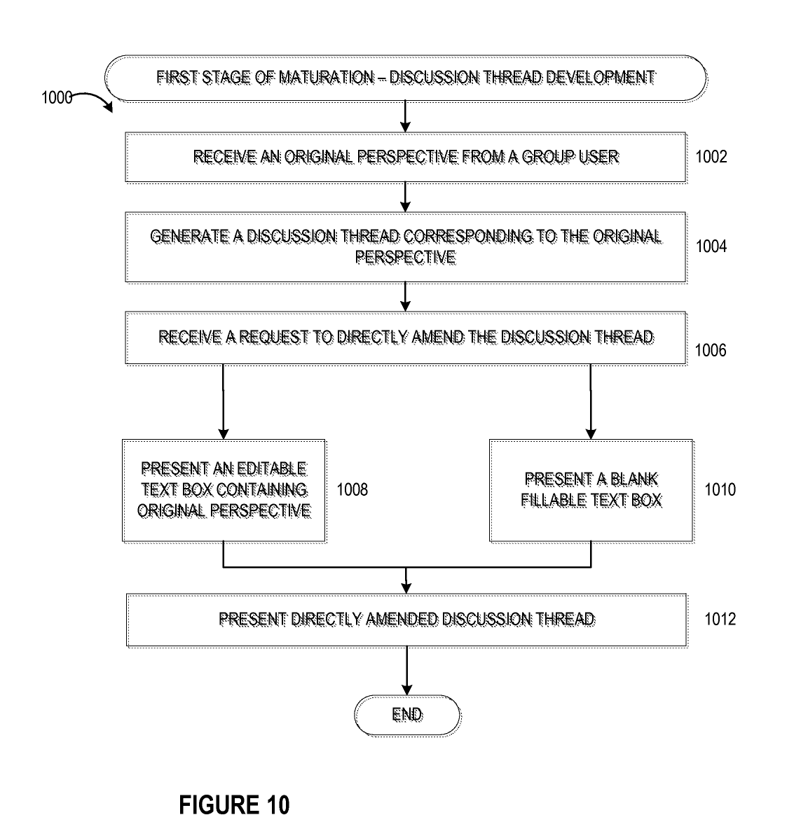

Referring now to FIG. 10, a flow diagram illustrating a process for directly amending an individual perspective according to one or more embodiments presented herein is shown. A routine 1000 begins at operation 1002, where the collaboration thread module 820 receives an original perspective from a user of a group. According to embodiments, the user may be able to submit an original perspective for a particular area of focus such that original perspectives pertaining to a particular area of focus can be grouped together and presented to users that have an interest in the particular area of focus. In addition, users may be able to submit an original perspective pertaining to either a half-baked driver thread or a key driver thread. From operation 1002, the routine 1000 proceeds to operation 1004, where the collaboration thread module 820 generates a collaboration thread 410 comprising the original lead perspective. According to embodiments, the collaboration thread 410 may include a title 412 and a description 414 that was submitted by the user. Although in various embodiments, the title and description may be in a text format, other embodiments may include rich media formats, such as video, audio, or other multimedia files.

From operation 1004, the routine 1000 proceeds to operation 1006, where the collaboration thread module 820 receives a request to perform a directed amendment. According to embodiments, the collaboration thread 410 may include selectable icons through which contributors 202 may submit directed amendments related to the collaboration thread 410. A directed amendment may be described as an amendment that directs a contributor 202 to amend a description in a specific manner so as to discourage the contributor 202 submitting the amendment from drifting too far away from the focus of the original perspective. For instance, according to the embodiments shown in FIG. 4, a collaboration thread 410 may include an enhance icon, a differ icon, and a flag icon for each of the descriptions 414 within the collaboration thread 410. The contributor 202 may select the enhance icon associated with a particular discussion to enhance the particular discussion. What this means is the contributor 202 may now be able to edit the description 414, such that when the contributor 202 submits his version of the description, the edited version of the description is shown. In some embodiments, the group-perspective collaboration system 120 may show a list of all the contributors 202 for each description. Furthermore, the group-perspective collaboration system 120 may show the last enhancement made to each description. In this way, contributor 202 may be able to roll back to a previous version of the description. Alternatively, the contributor 202 may select the differ icon associated with the particular discussion to create a separate description, in which case, the contributor 202 may submit a different perspective. As a result, the collaboration thread module 820 may present the different perspective as a separate description, such as the description 414B shown in FIG. 4. Moreover, the contributor 202 may select the flag icon to flag the description for deletion, for moving to a different area of focus, or merging with a different group perspective thread. As such, a directed amendment, as described in the present disclosure, may refer to enhancing a particular description by editing the particular description in place or differing from a particular description by submitting an entirely new description, and in some embodiments, flagging the description for deletion, moving, or merging.

From operation 1006, the routine 1000 proceeds to either operation 1008 or operation 1010. If the routine 1000 proceeds to operation 1008, where the collaboration thread module 820 receives a request to enhance an existing description 414A from a contributor 202. Upon receiving the request to enhance the existing description, the collaboration thread module 820 may present an editable text box containing the existing description to the contributor 202. The contributor 202 may edit the contents of the text box and submit the revised version of the existing description. From operation 1006, the routine 1000 proceeds to operation 1012, where the collaboration thread module 820 presents the updated collaboration thread including the revised description to the group of users. According to embodiments, the revised description may be displayed as a marked up version of the original lead perspective, or without any markings. In various embodiments, the last enhancement may be highlighted in some manner to indicate the most recent changes.

At operation 1006, if the routine 1000 proceeds to operation 1010, where the collaboration thread module 820 receives, from a contributor 202, a request to differ from an existing description 414A. Upon receiving the request to differ from the existing description, the collaboration thread module 820 may present a blank fillable text box to the contributor 202. The contributor 202 may enter his differing perspective and submit the different perspective.

From operation 1010, the routine proceeds to operation 1012, where the collaboration thread module 820 presents the updated collaboration thread including either the description containing the original lead perspective or an enhanced version thereof, or the second description 414B, which includes the different perspective, or both. From operation 1012, the routine 1000 ends.

It should be appreciated by those skilled in the art that the present disclosure may be utilized in a wide variety of industries. Although the disclosure is described as a method of group collaboration that delivers continuous high performance, it should be understood that the scope of the present disclosure is not limited to such methods. Rather, the disclosure presented herein may be utilized to allow a group of users to collaborate in a sophisticated manner with the aim to produce or extract quality signals from contributions provided by the group of users. As such, the group-perspective collaboration system 120 disclosed in the present disclosure may be configured to receive contributions from the group of users, and extract meaningful signals. In further embodiments, the group of users may be able to take actions on these extracted signals and receive feedback from the group.

In various embodiments of the present disclosure, embodiments for a system, computer-readable storage medium, and computer implemented method of group collaboration are disclosed. In some embodiments, a processor presents a user interface through which users of a group can collaborate with one another. A first perspective from a user of the group is received at a first stage of maturation. The first perspective is then presented as a first stage thread to the group for collaboration. The system determines whether an elevation condition has been met to elevate the first stage thread to a second stage of maturation. Upon determining that the elevation condition has been met, the system determines whether content similar to content associated with the first stage thread exists. Upon determining that content similar to content associated with the first stage thread does not exist, the system elevates the first stage thread from the first stage of maturation to the second stage of maturation.

It should be appreciated that the group-perspective collaboration system 120 may involve a server client relationship, in which the server may be a centralized system that communicates with one or more client computers, through which the group of users can collaborate with other users of the group. In addition, the server may be configured to present a user interface through which the users of the group may collaborate with one another. In addition, the server may also be configured to store data structures that may be utilized to store the perspectives submitted by the users.

It should further be appreciated that the present disclosure presents functionality that facilitates an improved group collaboration system. The group-perspective collaboration system 120, as described herein and shown in the drawings provided herein, demonstrate a three stage system. In the first stage, a user may submit a lead idea related to any topic for discussion. The system may create a thread based on the lead idea. The thread is now an entity for developing that particular idea further. As such, the thread has functionality built in that allows users to control the development of the idea. For instance, the thread allows users of the group to contribute to the thread by
Enhancing the lead perspective submitted by the user. This means amending the lead perspective in place such that amended version of the lead perspective is now presented as the lead perspective.
Submitting a differing perspective that differs from the lead idea such that the differing perspective is shown separately from the lead idea
Enhancing a previously submitted differing perspective or submitting a differing perspective that differs from both the lead idea and the previously submitting differing perspective
Voting for or against a particular perspective or the thread in general
Submitting a request to remove a perspective, move a perspective to another organizational area, or merge the perspective with another previously existing thread, and
Submitting a request to elevate a perspective or the thread to a next stage of maturation, amongst other types of contributions.
In the second stage of maturation, the system provides additional functionality and allows users to act as contributors to the second stage thread or as owners of the second stage thread. As contributors, they can perform the same functionality as they could in the first stage of maturation. However, some of the actions taken by contributors may be declined or monitored by the owners of the thread. The owners, on the other hand, have control of the thread and may accept or deny requests submitted by the contributors. In this way, the owners may be able to control the direction of the thread and remove “noise” from the thread. Further, the owners are capable of
Approving or denying requests submitted by the contributors
Merge the thread or perspectives within the thread with other threads
In some embodiments, elevate or submit a request to elevate the thread to a third stage of maturation.
In the third stage of maturation, the system provides additional functionality and allows the owners of the group to take actions on the third stage thread. As such, the owners may be able to create roadmaps, define actions to take, and implement actions based on the perspectives contained within the third stage threads. Upon taking actions, contributors of the third stage thread may be able to provide feedback on the actions taken. In various embodiments, the contributors may be able to provide feedback by submitting perspectives as first stage threads or second stage threads. Other contributors may then vote, submit additional perspectives, or perform other functionality on the feedback threads associated with the actions. These threads may derive key updates that may then be utilized by the owners to generate key actions. As a result, a feedback loop is created that results in a continuous improvement of key drivers.

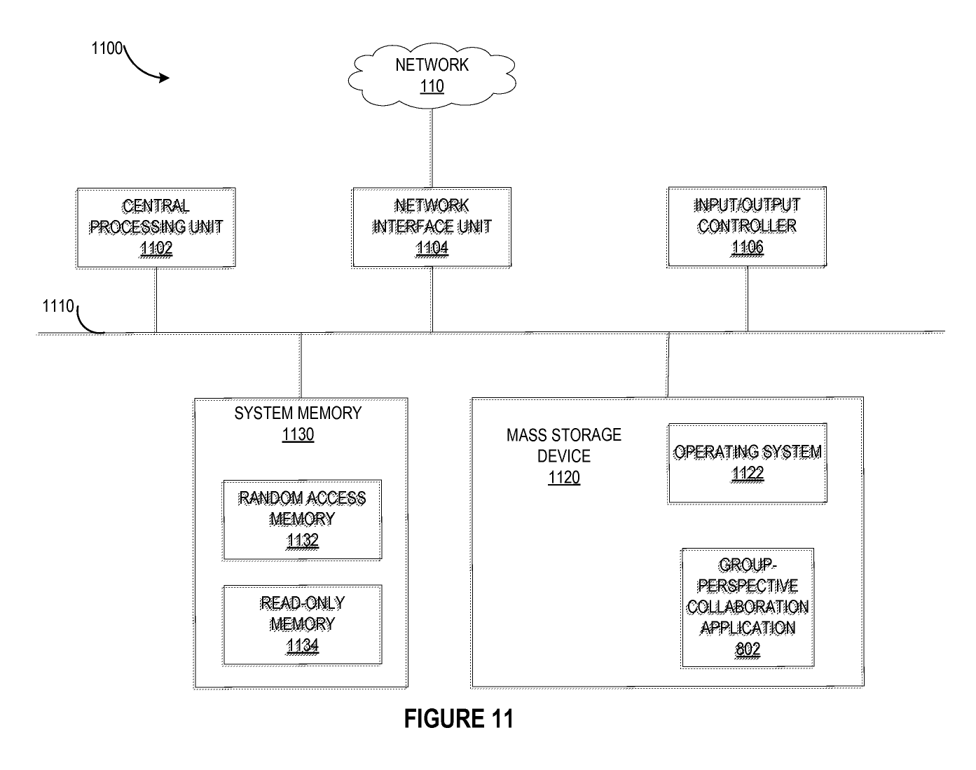

Referring now to FIG. 11, a computer architecture diagram illustrating computing system hardware capable of delivering continuous high performance using a group perspective collaboration system is shown. The computer architecture illustrated in FIG. 11 can include a central processing unit 1102 (CPU), a system memory 1130, including a random access memory 1132 (RAM) and a read-only memory 1134 (ROM), and a system bus 1110 that can couple the system memory 1130 to the CPU 1102. A basic input/output system containing the basic routines that help to transfer information between elements within the computer architecture 1100, such as during startup, can be stored in the ROM 1134. The computer architecture 1100 may further include a mass storage device 1120 for storing an operating system 1122, software, data, and various program modules, such as the group perspective collaboration application 802.

The mass storage device 1120 can be connected to the CPU 1102 through a mass storage controller (not illustrated) connected to the bus 1110. The mass storage device 1120 and its associated computer-readable media can provide non-volatile storage for the computer architecture 1100. Although the description of computer-readable media contained herein refers to a mass storage device, such as a hard disk or CD-ROM drive, it should be appreciated by those skilled in the art that computer-readable media can be any available computer storage media that can be accessed by the computer architecture 1100.

By way of example, and not limitation, computer-readable media may include volatile and non-volatile, removable and non-removable media implemented in any method or technology for the non-transitory storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer architecture 1100.

According to various embodiments, the computer architecture 1100 may operate in a networked environment using logical connections to remote computers through a network such as the network 110. The computer architecture 1100 may connect to the network 110 through a network interface unit 1104 connected to the bus 1110. It should be appreciated that the network interface unit 1104 may also be utilized to connect to other types of networks and remote computer systems. The computer architecture 1100 may also include an input/output controller 1106 for receiving and processing input from a number of other devices, including a keyboard, mouse, or electronic stylus (not illustrated). Similarly, an input/output controller 1106 may provide output to a video display, a printer, or other type of output device (also not illustrated).

As mentioned briefly above, a number of program modules and data files may be stored in the mass storage device 1120 and RAM 1132 of the computer architecture 1100, including an operating system 1122 suitable for controlling the operation of a networked desktop, laptop, server computer, or other computing environment. The mass storage device 1120, ROM 1134, and RAM 1132 may also store one or more program modules. In particular, the mass storage device 1120, the ROM 1134, and the RAM 1132 may store the group perspective collaboration application 802 for execution by the CPU 1102. The group perspective collaboration application 802 can include software components for implementing portions of the processes discussed in detail with respect to FIGS. 1-4. The mass storage device 1120, the ROM 1134, and the RAM 1132 may also store other types of program modules.

Software modules, such as the various modules within the group perspective collaboration application 802 may be associated with the system memory 1130, the mass storage device 1120, or otherwise. The group perspective collaboration application 802 may be able to provide users with a platform through which the users may deliver continuous high performance. According to embodiments, the group perspective collaboration application 202 may be stored on the wireless communications network 100 and executed by a central computing device. In other embodiments, the group perspective collaboration application 802 may be stored on the network 110 and executed by any computer within the network 110.

The software modules may include software instructions that, when loaded into the CPU 1102 and executed, transform a general-purpose computing system into a special-purpose computing system customized to facilitate all, or part of, group performance collaboration techniques disclosed herein. As detailed throughout this description, the program modules may provide various tools or techniques by which the computer architecture 1100 may participate within the overall systems or operating environments using the components, logic flows, and/or data structures discussed herein.

The CPU 1102 may be constructed from any number of transistors or other circuit elements, which may individually or collectively assume any number of states. More specifically, the CPU 1102 may operate as a state machine or finite-state machine. Such a machine may be transformed to a second machine, or specific machine by loading executable instructions contained within the program modules. These computer-executable instructions may transform the CPU 1102 by specifying how the CPU 1102 transitions between states, thereby transforming the transistors or other circuit elements constituting the CPU 1102 from a first machine to a second machine, wherein the second machine may be specifically configured to provide a platform to users through which the users may be able to deliver continuous high performance. The states of either machine may also be transformed by receiving input from one or more user input devices associated with the input/output controller 1106, the network interface unit 1104, other peripherals, other interfaces, or one or more users or other actors. Either machine may also transform states, or various physical characteristics of various output devices such as printers, speakers, video displays, or otherwise.

Encoding of the program modules may also transform the physical structure of the storage media. The specific transformation of physical structure may depend on various factors, in different implementations of this description. Examples of such factors may include, but are not limited to: the technology used to implement the storage media, whether the storage media are characterized as primary or secondary storage, and the like. For example, if the storage media are implemented as semiconductor-based memory, the program modules may transform the physical state of the system memory 1130 when the software is encoded therein. For example, the software may transform the state of transistors, capacitors, or other discrete circuit elements constituting the system memory 1130.

As another example, the storage media may be implemented using magnetic or optical technology. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. It should be appreciated that various other transformations of physical media are possible without departing from the scope and spirit of the present description.

Based on the foregoing, it should be appreciated that technologies for technologies for delivering continuous high performance using a group perspective collaboration system are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementation.

The subject matter described above is provided by way of illustration only and should not be construed as limiting. Various modifications and changes may be made to the subject matter described herein without following the example embodiments and applications illustrated and described, and without departing from the true spirit and scope of the present invention.

What is claimed is:

1. A computer implemented method of group collaboration, the method comprising:
through a computer, presenting a user interface through which users of a group can collaborate with one another;
receiving, via the computer, a first perspective from a user of the group at a first stage of maturation;
presenting, through the computer, the first perspective as a first stage thread to the group for collaboration;
determining whether an elevation condition has been met to elevate the first stage thread to a second stage of maturation;
upon determining that the elevation condition has been met, determining whether content similar to content associated with the first stage thread exists; and
upon determining that content similar to content associated with the first stage thread does not exist, elevating, through the computer, the first stage thread from the first stage of maturation to the second stage of maturation.

2. The method of claim 1, wherein determining whether an elevation condition has been met comprises determining whether a user has submitted a request to elevate the first stage thread to the second stage of maturation.

3. The method of claim 1, wherein determining whether an elevation condition has been met comprises determining a maturation score of the first stage thread based on activities associated with the first stage thread, and comparing the determined maturation score with a threshold first stage maturation score.

4. The method of claim 1, wherein determining whether content similar to content associated with the first stage thread exists comprises determining the content associated with the first stage thread, and searching for content that is similar to the content associated with the first stage thread.

5. The method of claim 4, wherein searching for content that is similar to the content associated with the first stage thread comprises a keyword search using words from the first stage thread.

6. The method of claim 1, further comprising:
converting the first stage thread to a second stage thread in the second stage of maturation;
assigning ownership rights to one or more owner-users of the group; and
providing, through the computer, the owner-users control of the second stage thread.

7. The method of claim 1, further comprising:
determining an activity score of the first stage thread;
upon determining that the activity score of the first stage thread falls below a threshold activity score, removing the first stage thread.

8. A system of group collaboration, the system comprising:
a processor;
a memory coupled to the processor, the memory having computer-executable instructions stored thereon, which when executed by the processor, cause the processor to
present a user interface through which users of a group can collaborate with one another,
receive a first perspective from a user of the group at a first stage of maturation,
present the first perspective as a first stage thread to the group for collaboration,
determine whether an elevation condition has been met to elevate the first stage thread to a second stage of maturation,
upon determining that the elevation condition has been met, determine whether content similar to content associated with the first stage thread exists, and
upon determining that content similar to content associated with the first stage thread does not exist, elevate the first stage thread from the first stage of maturation to the second stage of maturation.

9. The system of claim 8, wherein determining whether an elevation condition has been met comprises determining whether a user has submitted a request to elevate the first stage thread to the second stage of maturation.

10. The system of claim 8, wherein determining whether an elevation condition has been met comprises determining a maturation score of the first stage thread based on activities associated with the first stage thread, and comparing the determined maturation score with a threshold first stage maturation score.

11. The system of claim 8, wherein determining whether content similar to content associated with the first stage thread exists comprises determining the content associated with the first stage thread, and searching for content that is similar to the content associated with the first stage thread.

12. The system of claim 11, wherein searching for content that is similar to the content associated with the first stage thread comprises a keyword search using words from the first stage thread.

13. The system of claim 8, further comprising:
converting the first stage thread to a second stage thread in the second stage of maturation;
assigning ownership rights to one or more owner-users of the group; and
providing, through the computer, the owner-users control of the second stage thread.

14. The system of claim 8, further comprising:
determining an activity score of the first stage thread;
upon determining that the activity score of the first stage thread falls below a threshold activity score, removing the first stage thread.

15. A computer-readable storage medium having computer-executable instructions stored thereon, which when executed by a computer, cause the computer to:
present a user interface through which users of a group can collaborate with one another;
receive a first perspective from a user of the group at a first stage of maturation;
present the first perspective as a first stage thread to the group for collaboration;
determine whether an elevation condition has been met to elevate the first stage thread to a second stage of maturation;
upon determining that the elevation condition has been met, determine whether content similar to content associated with the first stage thread exists; and
upon determining that content similar to content associated with the first stage thread does not exist, elevate the first stage thread from the first stage of maturation to the second stage of maturation.

16. The computer-readable storage medium of claim 15, wherein determining whether an elevation condition has been met comprises determining whether a user has submitted a request to elevate the first stage thread to the second stage of maturation.

17. The computer-readable storage medium of claim 15, wherein determining whether an elevation condition has been met comprises determining a maturation score of the first stage thread based on activities associated with the first stage thread, and comparing the determined maturation score with a threshold first stage maturation score.

18. The computer-readable storage medium of claim 15, wherein determining whether content similar to content associated with the first stage thread exists comprises determining the content associated with the first stage thread, and searching for content that is similar to the content associated with the first stage thread.

19. The computer-readable storage medium of claim 18, wherein searching for content that is similar to the content associated with the first stage thread comprises a keyword search using words from the first stage thread.

20. The computer-readable storage medium of claim 15, further comprising:
converting the first stage thread to a second stage thread in the second stage of maturation;
assigning ownership rights to one or more owner-users of the group; and
providing, through the computer, the owner-users control of the second stage thread.
